(19) United States
(12) Patent Application Publication
(10) Pub. No.: US 2015/0355946 A1
(43) Pub. Date: Dec. 10, 2015

(54) “Systems of System” and method for Virtualization and Cloud Computing System

(71) Applicant: Dan-Chyi Kang, Palo Alto, CA (US)

(72) Inventor: Dan-Chyi Kang, Palo Alto, CA (US)

(21) Appl. No.: 14/301,321

(22) Filed: Jun. 10, 2014

(51) Int. Cl. G06F 9/50; G06F 12/08; G06F 9/48

(52) U.S. Cl. CPC G06F 9/5011; G06F 9/4881; G06F 12/0842; G06F 2212/62

(57) ABSTRACT

A “systems of system” and method for virtualization and cloud computing system are disclosed. According to one embodiment FIG. 1, a “systems of system” comprises at least two systems. The first system includes multi-core processing cluster, multi-tasking operating system with application software stacks, and the second system includes identical or non-identical multi-core processing cluster, real time operating system with real time software stacks in communication with a network interface card, PCI-e and software instructions. When the software instructions are sent from first system to the second system and executed by the second system they cause the second system to receive a request for a service, create a new or invoke an existing software or virtual machine to service the request, and return a desired result indicative of successful completion of the service to the first system.

The second system, within or external to the first system, can be expanded into multiple identical or non-identical systems. Each system within can invoke its own applications and has its own software stack with the software applications running concurrently in the software stacks of first system. By expanding both hardware infrastructure and software infrastructure, the second system can expanded into multiple systems, virtualized or non-virtualized, the resources of overall “systems of system” can be dynamically expanded based on the type of applications, loading of applications and users' requirements into on-demand cloud computing system.

### INCORPORATION BY REFERENCE

This application is a Continuous-In-Part to application No. U.S. Ser. No. 13/732,143, having an International Filing Date of Dec. 31, 2012, entitled “Partitioning processes across clusters by process type to optimize use of cluster specific configurations” which claims priority of co-pending PCT Application No. PCT/US2011/042866, having an International Filing Date of Jul. 1, 2011, entitled “A SYSTEM AND METHOD FOR VIRTUALIZATION AND CLOUD SECURITY”, which claims the benefit of priority to U.S. Provisional Application Ser. No. 61/360,658, filed Jul. 1, 2010, and entitled “A SYSTEM AND METHOD FOR CLOUD SECURITY MANAGEMENT”, which are all hereby incorporated by reference, as if set forth in full in this document, for all purposes.

### FIELD

The present methods and system relate to computer systems, and more particularly, to data driven applications allocation among processor clusters.

### BACKGROUND

Virtualization, in computing, is the creation of a virtual (rather than actual) version of something, such as a hardware platform, an operating system, a storage device or network resources. Virtualization is part of an overall trend in enterprise IT that includes autonomic computing, a scenario in which the IT environment will be able to manage itself based on perceived activity, and utility computing, in which computer processing power is seen as a utility that clients can pay for only as needed. The usual goal of virtualization is to centralize administrative tasks while improving scalability and workloads.

The aggregation of a large number of users using high-speed personal computers, smart phones, tablet computers, and intelligent mobile devices significantly increases required network packet processing performance in a non-virtualized and virtualized server of data center environment. Processing on each complicated packet from various mobile devices is necessary to differentiate and secure services. Green computing is becoming essential to limit power consumption. In addition, shortened infrastructure deployment schedules can result in faster revenue generation.

Recent technology improvements can achieve the expected level of performance while providing a scalable solution with unrivalled performance in integration and power consumption ratio. Some of those included multi-core CPUs and hardware industry standards such as the AMC standard, the PCI Express standard, RapidIO standard, the Advanced TCA standard, and the Blade Center standard.

High performance software packet processing is typically required to efficiently implement the different protocols and ensure an adequate quality of service. Most advanced networks have adopted a class-based quality of service concept so they require per-packet processing for differentiating between packet services.

Traffic between a data center and remote users is often encrypted using IPSec and requires the assistance of hardware crypto engines. Multi-core technology provides necessary processing capabilities and offers a high level of integration with lower power consumption required by advanced networks. However, software design complexities persist, making development and integration difficult. The result is a hindrance to deployment of multi-core based solutions.

With virtualization and cloud computing gradually becoming more and more popular, existing servers can be logically grouped into a single, large pool of available resources. Aggregating the capacity of these devices into a single pool of available resources enables efficient utilization of servers which results in a related reduction in both capital and operational expenses. However, virtualization leaves traditional network security measures inadequate to protect against the emerging security threats in the virtual environment. This is due to a lack of major protection in the data path between servers and storage subsystems. The lack of protection prevents enterprises from experiencing the full benefits of a major data center transformation.

While cloud computing is often seen as increasing security risks and introducing new threat vectors, it also presents an exciting opportunity to improve security. Characteristics of clouds such as standardization, automation, and increased visibility into the infrastructure can dramatically boost security levels. Running computing services in isolated domains, providing default encryption of data in motion and at rest, and controlling data through virtual storage have all become activities that can improve accountability and reduce the loss of data. In addition, automated provisioning and reclamation of hardened run-time images can reduce the attack surface and improve forensics.

As information and communication technology industry continues its shift into the 3^{rd} platform, which includes the mobile/social/cloud/big data world. With the widespread adoption of sophisticated virtualized applications within cloud infrastructure, the massive network traffics in data center are exploding due to high density of VMs (virtual machines) and mobile devices/cloud services adoption; therefore, the performance of virtualized server and access of network/storage becomes a critical factor due to the significant shift of data center technologies away from client/server architecture. In addition, to solve the network and IO bottleneck of bandwidth and latency issues in converged infrastructure platform (or called cloud computing platform combining server, storage and network systems together with the management software) due to rise of new service provisions are the major challenges for emerging servers and cloud computing platforms used in datacenter and public/private clouds.

### SUMMARY

In one aspect of the invention, a distributed computing system, comprising: a network interface and/or an inter-processor communication link is disclosed; a first processing cluster coupled to the network interface and/or the inter-processor communication link, the first processing cluster comprising one or more hardware cores, wherein the first processing cluster is configured to execute a multitasking operating system and/or is configured to use a multitasking instruction set; a second processing cluster coupled to the network interface and/or the inter-processor communication link, coupled to the first processing cluster, wherein the second processing cluster comprises one or more hardware cores, wherein the second processing cluster is configured to execute a real-time operating system and/or is configured to use a real-time instruction set; a first set of agents that are executed by the real-time operating system and that are configured to receive real-time processing requests from the first processing cluster and return processing results for those real-time processing requests to the first processing cluster; and a set of software stacks that allocate processes of a program executing on the first processing cluster according to real-time processing needs specific to the processes, thereby routing processes needing real-time processing to the second processing cluster, wherein the real-time processing requests comprises one or more I/O functions. In one embodiment, the one or more I/O functions is comprised of a data cache function and an I/O software control function. In one embodiment, the I/O function stores and organizes at least one computer file and access the computer file when requested.

In one embodiment, the computer file is located in a storage device in a local system or over a network. In one embodiment, the storage device is a hard disk, a CD—ROM or SSD or non-volatile memory (NVM) or hybrid storage mixed hard disk and SSD/NVM. In one embodiment, the computer files can be managed, accessed, read, stored and maintained by file systems as a shared file system, and/or a network file system, and/or an object file system. In one embodiment, the multiple computer files are located in a storage device in a local system or over a network. In one embodiment, the storage devices are multiple hard disks, CD-ROMs and/or SSDs and/or non-volatile memories (NVM) and/or hybrid storages mixed hard disks and SSDs/NVM. In one embodiment, the multiple computer files can be managed, accessed, read, stored and maintained by one or more file systems as a shared file system, and/or a network file system, and/or an object file system. In one embodiment, the first processing cluster is managed by a virtualized server system. In one embodiment, the second processing cluster further comprises a real-time hypervisor that coordinates multiple cores of the second processing cluster to allocate requests for services from the first processing cluster to virtual machines executed by cores of the second processing cluster managed by the real-time hypervisor.

In one embodiment, the first processing cluster is managed by a multitasking hypervisor or a multitasking operating system with more than one cores. In one embodiment, the first processing cluster has more than one identical cluster is managed by a multitasking hypervisor or a multitasking operating system with more than one clusters. In one embodiment, the second processing cluster is managed by a real-time hypervisor or a real-time operating system with more than one clusters.

In one embodiment, the second processing cluster has more than one identical clusters is managed by a real-time hypervisor or a real-time operating system consist of at least two clusters. In one embodiment, the system comprising: application layer server agents, middleware server agents executing in the second processing cluster; and corresponding middleware sockets, middleware client agents executing in the first processing cluster. In one embodiment, the second processing cluster comprises a plurality of types of cores, with at least two distinct cores optimized for distinct operations. In one embodiment, the second processing cluster comprises a plurality of types of cores, with at least two distinct clusters optimized for distinct operations. In one embodiment, the distinct operations include the I/O function, network function, network services, a security function, a rich content media compression (encoding) and decompression (decoding) function.

In one embodiment, the second processing cluster comprises a plurality of types of cores, with at least two distinct cores optimized for more than one distinct operation. In one embodiment, the second processing cluster comprises a plurality of types of cores, with at least two distinct clusters optimized for more than one distinct operations. In one embodiment, the one or more data cache functions can be implemented with DRAM, SRAM, SSD, non-volatile memory (NVM) or hybrid data cache among different memories, DRAM, SRAM, SSD, and NVM.

In one embodiment, the one or more data cache functions can use more than one DRAM, SRAM, SSD, non-volatile memory (NVM) as data cache or more than one hybrid data cache among different memories, DRAM, SRAM, SSD, and NVM as data cache.

In one embodiment, the system comprises program code to implement one or more I/O function, network function, network services, VLAN, Link Aggregation, GRE encapsulation, GTP and IP over IP tunneling, Layer 2/3 forwarding with virtual routing management, routing and virtual routing, network overlay termination, TCP termination, traffic management, service chaining, scaling to unlimited flows, virtual address mapping functions and buffer management, a security function, a rich content media compression (encoding) and decompression (decoding) function.

In one embodiment, a new program code can be downloaded by the middleware client agent in the first processing cluster and to the second processing cluster for execution by the application layer server agents and the middleware server agents and the middleware client agents. In one embodiment, a new virtual machine can be downloaded by the middleware client agent in the first processing cluster and to the second processing cluster for execution by the application layer server agents and the middleware server agents and the middleware client agents. In one embodiment, a new service can be downloaded by the middleware client agent in the first processing cluster and to the second processing cluster for execution by the application layer server agents and the middleware server agents and the middleware client agents.

In one embodiment, the first processing cluster comprises a plurality of types of cores, is managed by a multitasking hypervisor or a multitasking operating system with more than one cores with more than two clusters and at least two distinct cores optimized for distinct operations. In one embodiment, the first processing cluster comprises a plurality of types of cores, is managed by a multitasking hypervisor or a multitasking operating system with more than one clusters with at least two distinct clusters optimized for distinct operations. In one embodiment, the first processing cluster comprises a plurality of application stacks is managed by a multitasking hypervisor or a multitasking operating system with more than one cores with more than two clusters and at least two distinct cores optimized for distinct operations. In one embodiment, the first processing cluster comprises a plurality of application stacks is managed by a multitasking hypervisor or a multitasking operating system with more than one clusters with at least two distinct clusters optimized for distinct operations. In one embodiment, the second processing cluster comprises a plurality of types of real time application stacks, with more than two clusters and at least two distinct cores optimized for distinct operations. In one embodiment, the second processing cluster comprises a plurality of types of real time application stacks, with at least two distinct clusters optimized for distinct operations. In one embodiment, the second processing cluster comprises a plurality of types of real time application stacks, with more than two clusters and at least two distinct cores optimized for distinct operations. In one embodiment, second processing cluster comprises a plurality of types of real time application stacks, with at least two distinct clusters optimized for distinct operations.

In another aspect of the invention, a method of computing over a distributed system is disclosed, comprising: a. executing application processes using a multitasking cluster, the multitasking cluster comprising one or more hardware cores configured to execute a multitasking operating system and/or configured to use a multitasking instruction set; b. executing a real-time operations cluster comprising one or more hardware cores configured to execute a real-time operating system and/or configured to use a real-time instruction set wherein the real-time instruction set is comprised of one or more I/O function; c. parsing operations of an application into real-time and non-real-time processes; d. communicating the real-time processes as requests over a network connection and/or an inter-processor communication link from the multitasking processing cluster to the real-time operations cluster; and e. providing real-time process results from the real-time operations cluster to the multitasking cluster. In one embodiment, the one or more I/O function is comprised of a data cache function and an I/O software control function. In one embodiment, the I/O function stores and organizes at least one computer file and access the computer file when requested. In one embodiment, the computer file and data is located in a storage device in a local system or over a network. In one embodiment, the storage device is a hard disk, a CD—ROM or a SSD, or non-volatile memory (NVM) or hybrid storage mixed hard disk and SSD/NVM.

In one embodiment, the first processing cluster comprises a plurality of types of cores, is managed by a multitasking hypervisor or a multitasking operating system with more than one cores with at least two distinct cores optimized for distinct operations. In one embodiment, the first processing cluster comprises a plurality of types of cores, is managed by a multitasking hypervisor or a multitasking operating system with more than one clusters with more than two clusters and at least two distinct clusters optimized for distinct operations. In one embodiment, the first processing cluster comprises a plurality of application stacks is managed by a multitasking hypervisor or a multitasking operating system with more than one cores with at least two distinct cores optimized for distinct operations. In one embodiment, the first processing cluster comprises a plurality of application stacks is managed by a multitasking hypervisor or a multitasking operating system with more than one clusters with at least two distinct clusters optimized for distinct operations. In one embodiment, the second processing cluster comprises a plurality of types of real time application stacks, with more than two clusters and at least two distinct cores optimized for distinct operations. In one embodiment, the second processing cluster comprises a plurality of types of real time application stacks, with more than two clusters and at least two distinct clusters optimized for distinct operations. In one embodiment, the second processing cluster comprises a plurality of types of real time application stacks, with more than two clusters and at least two distinct cores optimized for distinct operations. In one embodiment, the second processing cluster comprises a plurality of types of real time application stacks, with more than two clusters and at least two distinct clusters optimized for distinct operations.

### BRIEF DESCRIPTION OF THE DRAWINGS

The accompanying drawings, which are included as part of the present specification, illustrate the presently preferred embodiment and, together with the general description given above and the detailed description of the preferred embodiment given below, serve to explain and teach the principles described herein.

FIG. 1 illustrates an exemplary system level layout for use with the present first system, virtualization and cloud security system integrated with or into standard server system according to one embodiment.

FIG. 1A illustrates an exemplary system level layout for use with the present second system, virtualization and cloud network and I/O system integrated with or into standard server system according to one embodiment.

FIG. 2 illustrates an exemplary system level layout including a virtualization and cloud security system architecture and real time software stacks for use with the present first system according to one embodiment.

FIG. 2A illustrates an exemplary system level layout including a virtualization and cloud network and I/O system architecture and real time software stacks for use with the present second system, according to one embodiment.

FIG. 3 illustrates an exemplary software infrastructure for use with the present systems, according to one embodiment.

FIG. 4 illustrates an exemplary hardware infrastructure and expansion for use with the present system, according to one embodiment.

FIG. 5 illustrates an exemplary hardware infrastructure implementation for use with the present first system with multiple expansions of security system applications according to one embodiment.

FIG. 5A illustrates an exemplary hardware infrastructure implementation for use with the multiple second present systems with multiple expansions of virtualization and cloud network I/O systems.

FIG. 5B illustrates an exemplary high-level system layout for use with the expansion of intermixing multiple present security system and Network and I/O system according to one embodiment.

FIG. 5C illustrates an exemplary hardware infrastructure implementation for use with the expansion of present security systems and Network and I/O systems and software stacks associated with each system, according to one embodiment.

FIG. 5D illustrates an exemplary hardware infrastructure implementation for use with the expansion of intermixing present security system, Network and I/O system and future New Data system and associated software stacks according to one embodiment.

FIG. 5E illustrates an exemplary hardware infrastructure implementation for use with the expansion of intermixing present security system, Network and I/O system and future New Data system and associated software stacks, according to one embodiment.

FIG. 6 illustrates an exemplary system level layout with virtualization support for use with the present virtualized security system integrated with or into virtualized server system according to one embodiment.

FIG. 6A illustrates an exemplary system level layout with virtualization support for use with the present virtualized Network and I/O system integrated with or into virtualized server system according to one embodiment.

FIG. 6B illustrates an exemplary system level layout with virtualization support for use with the future virtualized New I/O system integrated with or into virtualized server system according to one embodiment.

FIG. 6C illustrates an exemplary system level layout with virtualization support for use with the expansion of intermixing present virtualized security system and virtualized Network and I/O system integrated with or into virtualized server system according to one embodiment.

FIG. 6D illustrates an exemplary system level layout with virtualization support for use with the future virtualized New Data system integrated with or into virtualized server system according to one embodiment.

FIG. 6E illustrates an exemplary system level layout with virtualization support for use with the expansion of intermixing virtualized Network and I/O system and virtualized New Data system integrated into virtualized server system according to one embodiment.

FIG. 7 illustrates a block diagram of the Freescale QorIQ T4240 Multi-core processor.

FIG. 8 illustrates a block diagram of the Cavium Octeon III CN78XX series Multi-core processor.

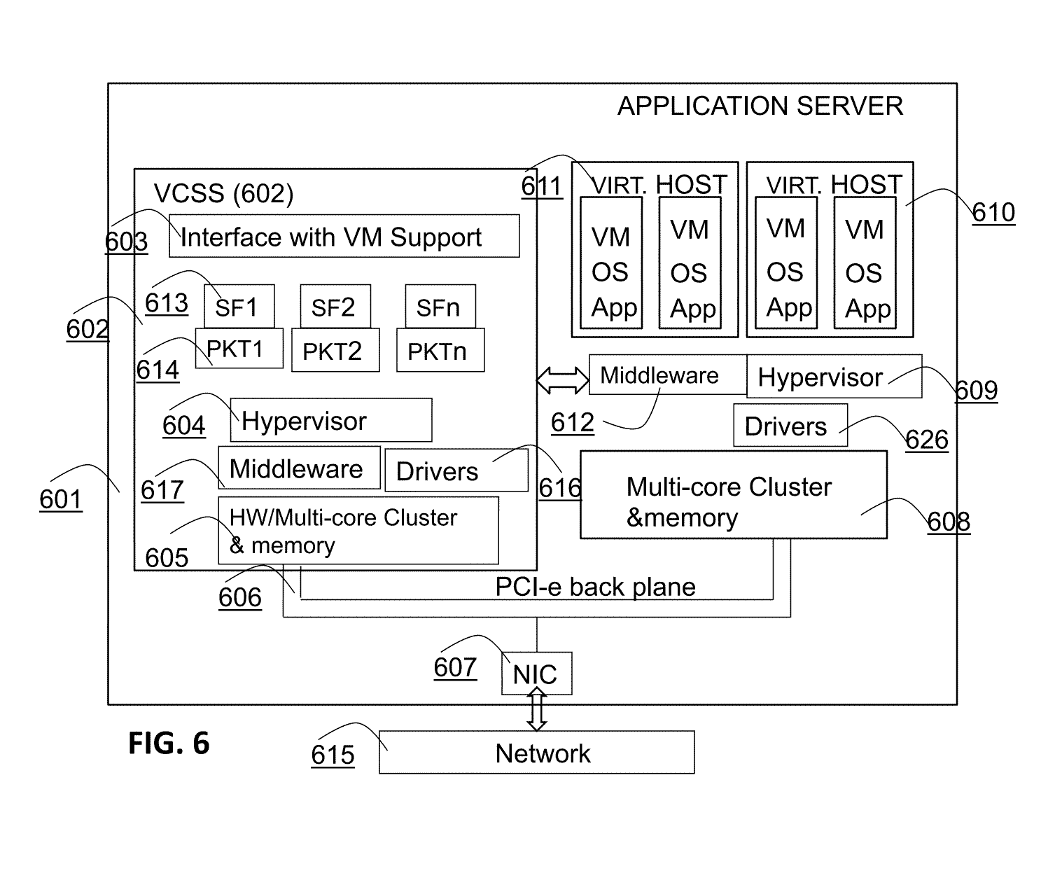

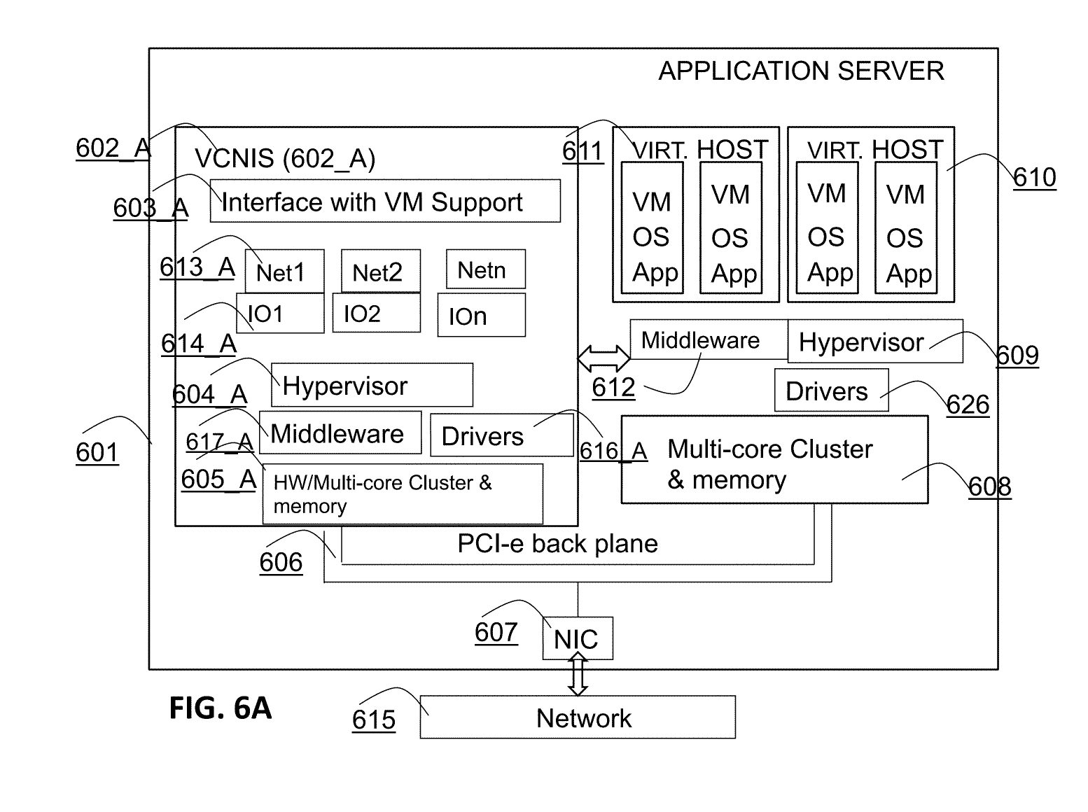

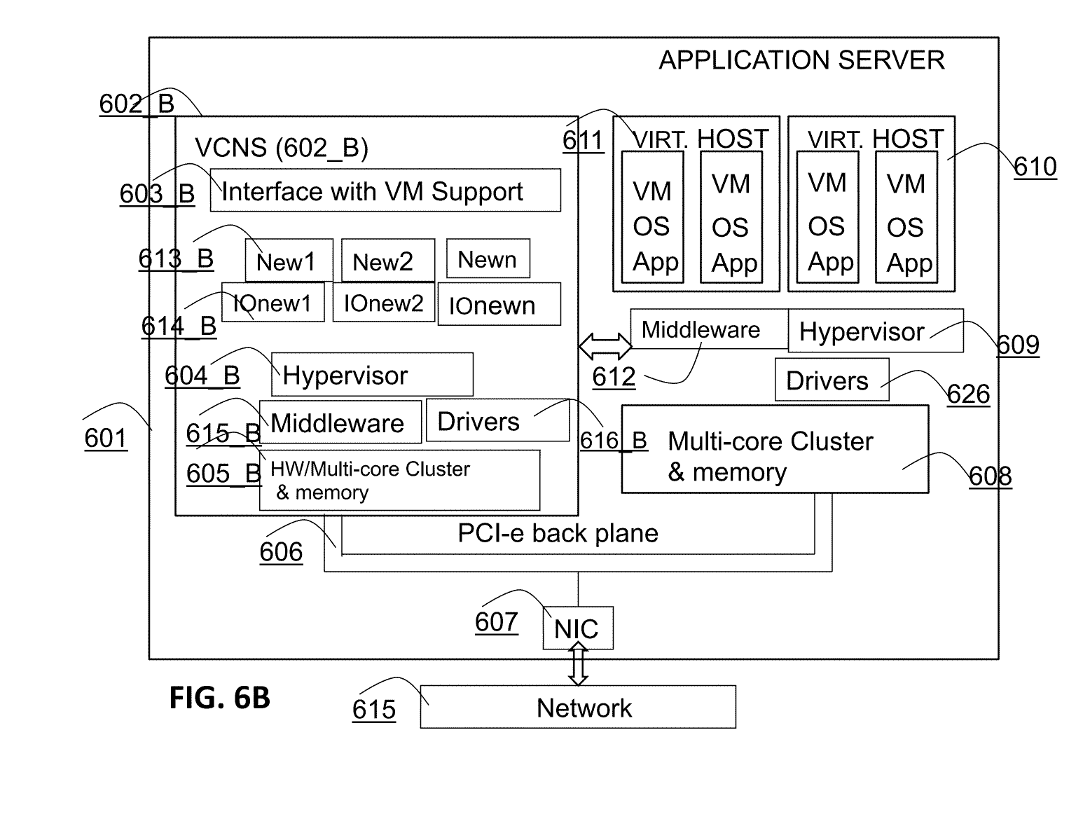

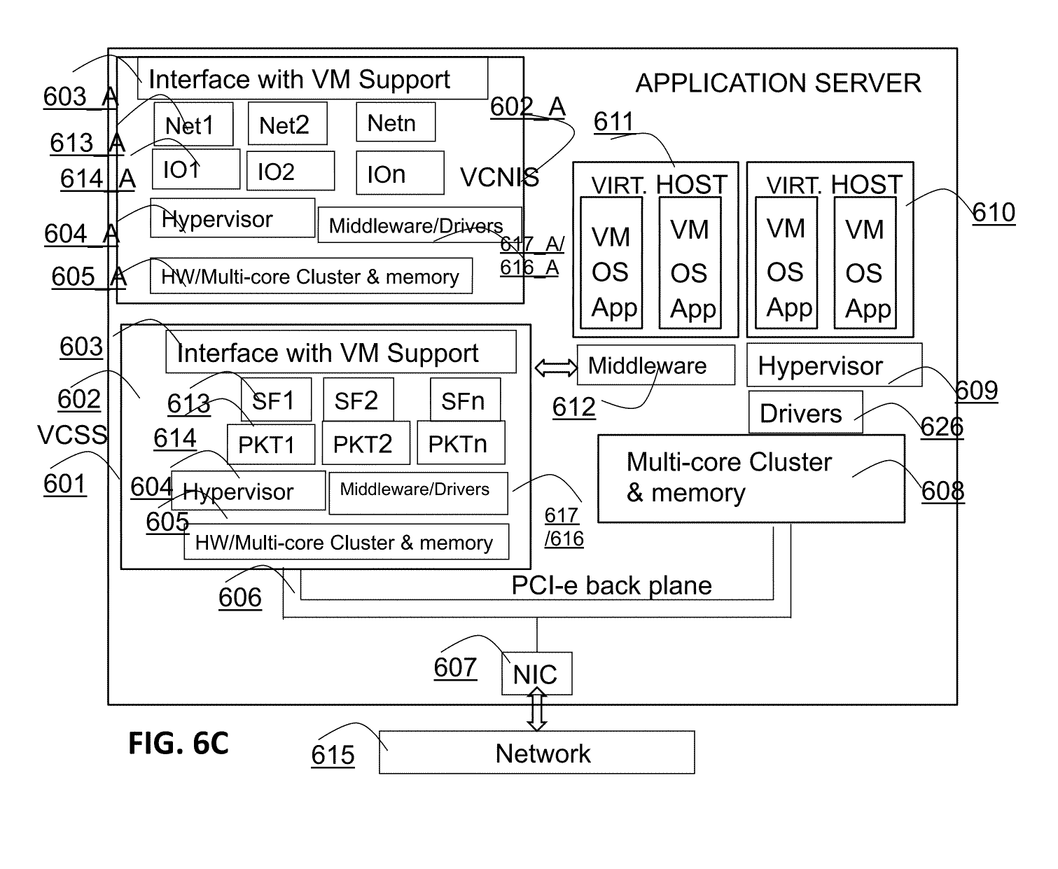

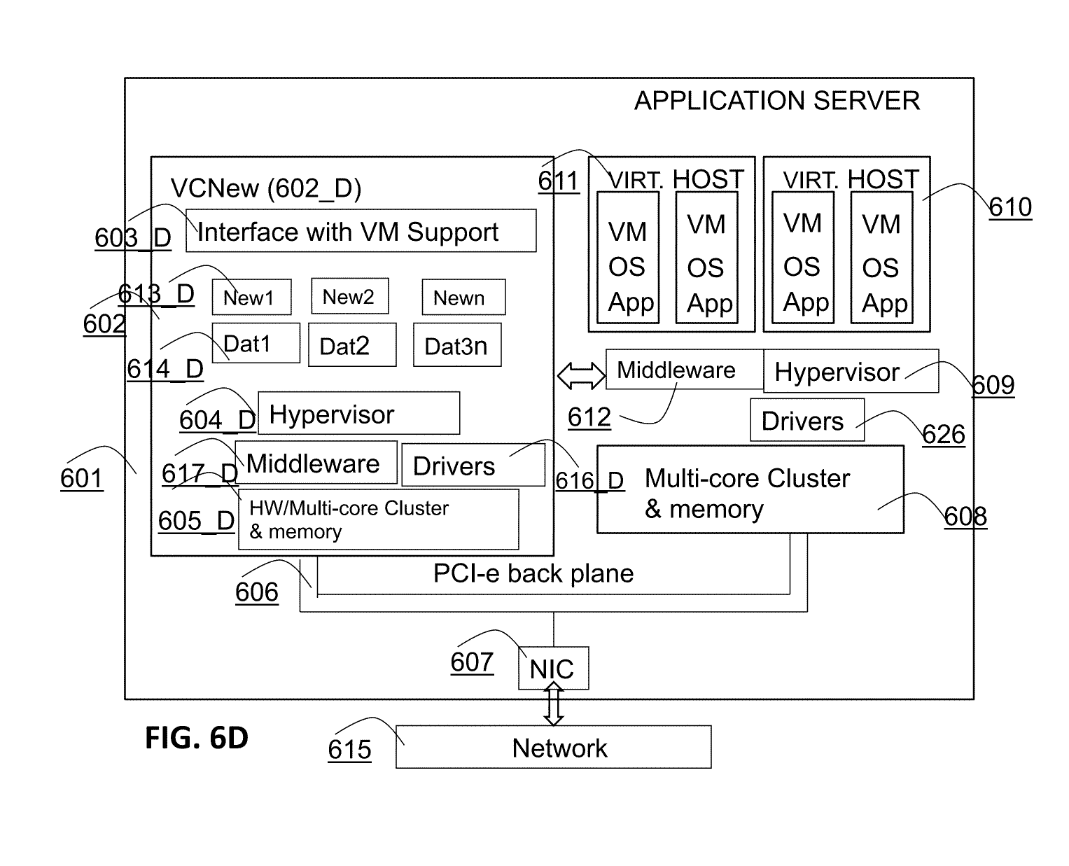

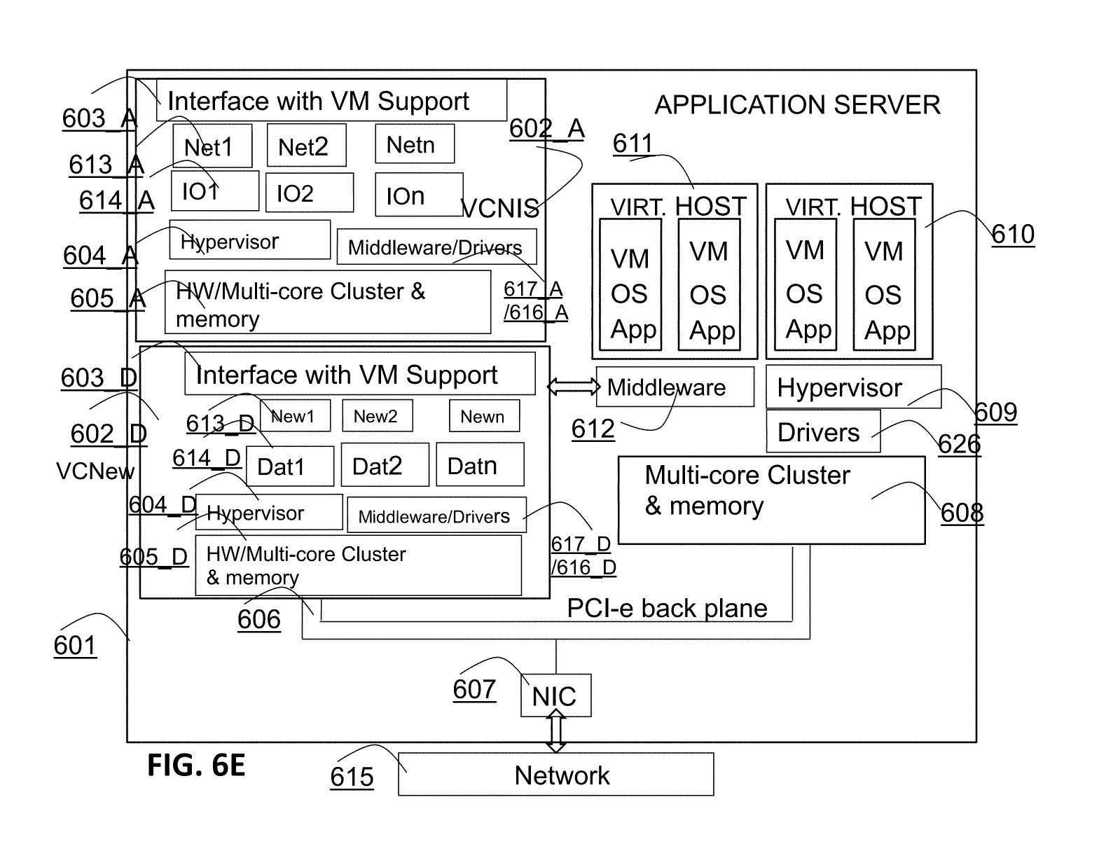

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims. For example, we can expand the exemplary system in FIG. 6C to include virtualization support of first system (602), second system (602_A) and new system (602_B) into present system or include virtualization support for (602), (602_A), (602_B) and (602_D) into present system.

### DETAILED DESCRIPTION

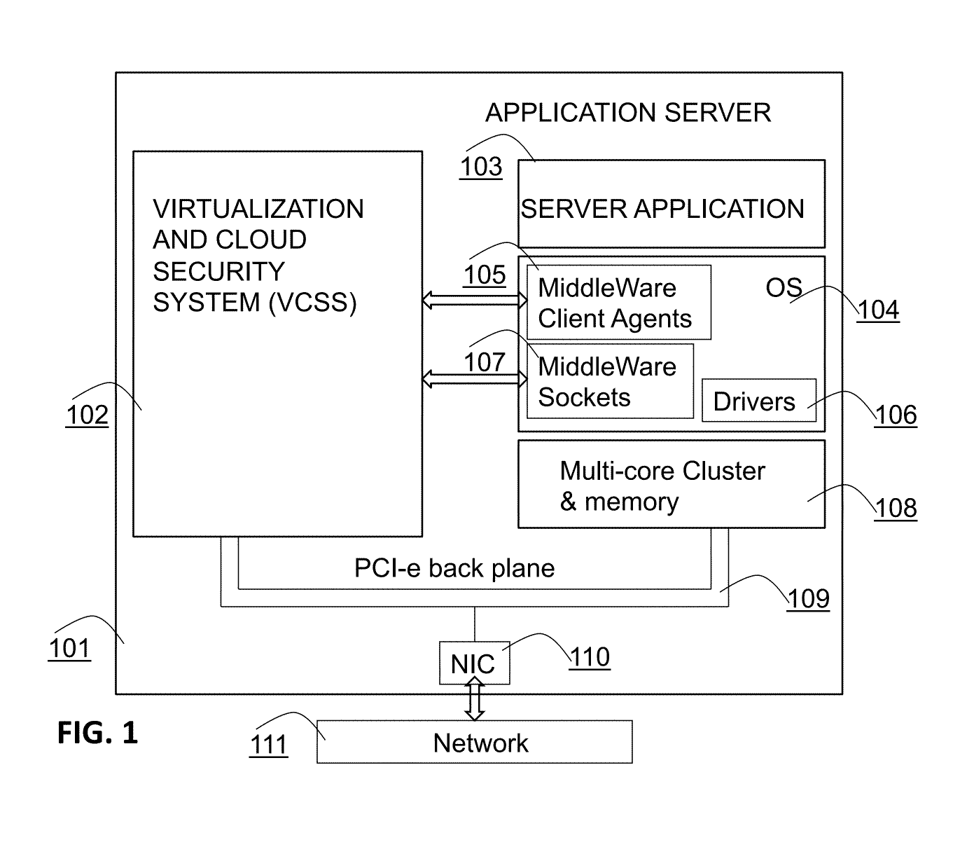

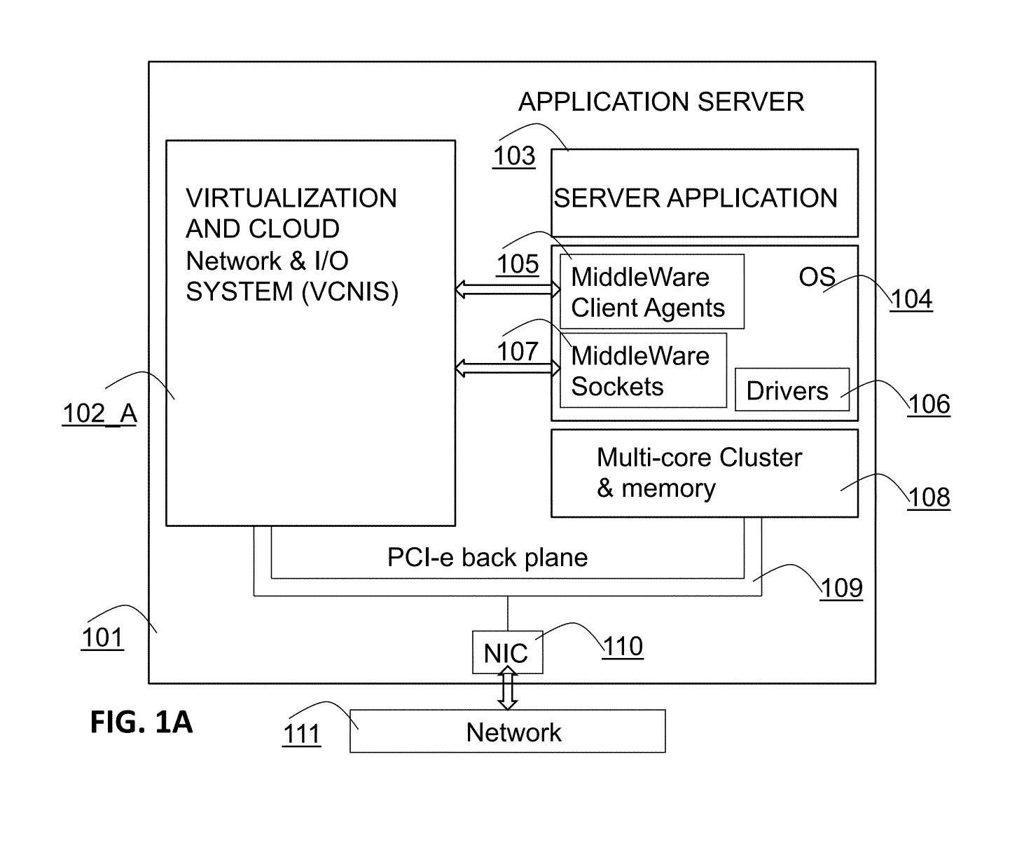

A “systems of system” and method for virtualization and cloud security system are disclosed. According to one embodiment, FIG. 1 illustrates a system (101) comprising a first system with multi-core processing cluster (108), which is controlled by multi-tasking OS (104) in communication with a network interface cards (110) or via PCI-e backplane (109) and software instructions (105) to the system VCSS (102), when installed and activated, through interface. When the software instructions (105) are executed by the second non-identical or identical multi-core processing cluster (211) of system (102), which is controlled by real time operating system RTOS (213) inside of system (102), they cause the second non-identical or identical multi-core processing cluster (211) to receive a request for a service, create a new or invoke an existing software functions to service the request, and return a desired result through software instructions (107) and interface (110) or (109) indicative of successful completion of the service to the first system.

FIG. 1 illustrates an exemplary system level layout for use with the present system, according to one embodiment. An application server (101) is running a server application (103). The application server (101) has an multitasking operating system (OS) (104), which can be from commercial products like Windows, Linux and Unix from different vendors, middleware sockets (107) and middleware agents (105), drivers 106, which are used to communicate between (OS) (104) and network interface cards (NIC) (110) and other hardware resources. The application server (101) is running a multi-core cluster (108) for server application (103), which requires packet processing or security software services, and communicates with a NIC (110) or via PCI-e (PCI Express) backplane (109) if system (102) is not installed or activated. The NICs 110 provide network 111 access. The device drivers (106) or (206) (commonly referred to as simply a driver) is a computer program that operates or controls a particular type of device that is attached to a computer like NIC (110). When system (102) is installed and activated, the middleware sockets (107) and agents (105) are in communication with a virtualization and cloud security system VCSS (102) according to the embodiments disclosed herein.

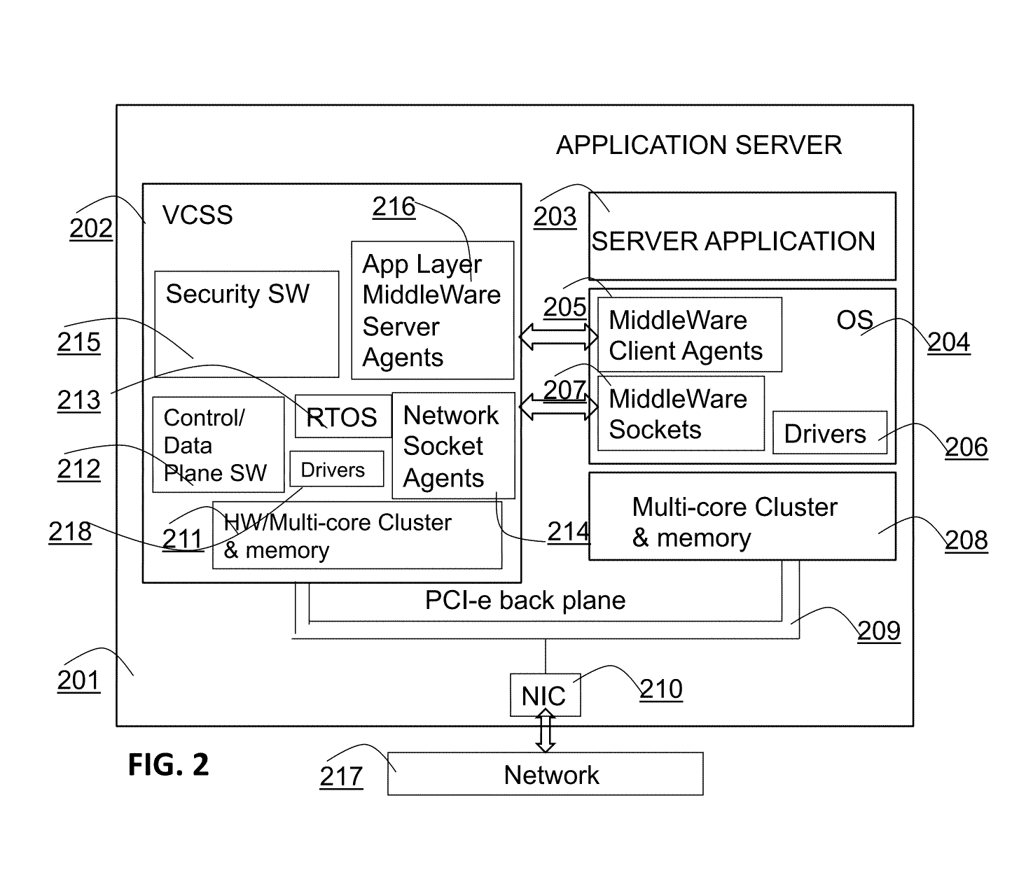

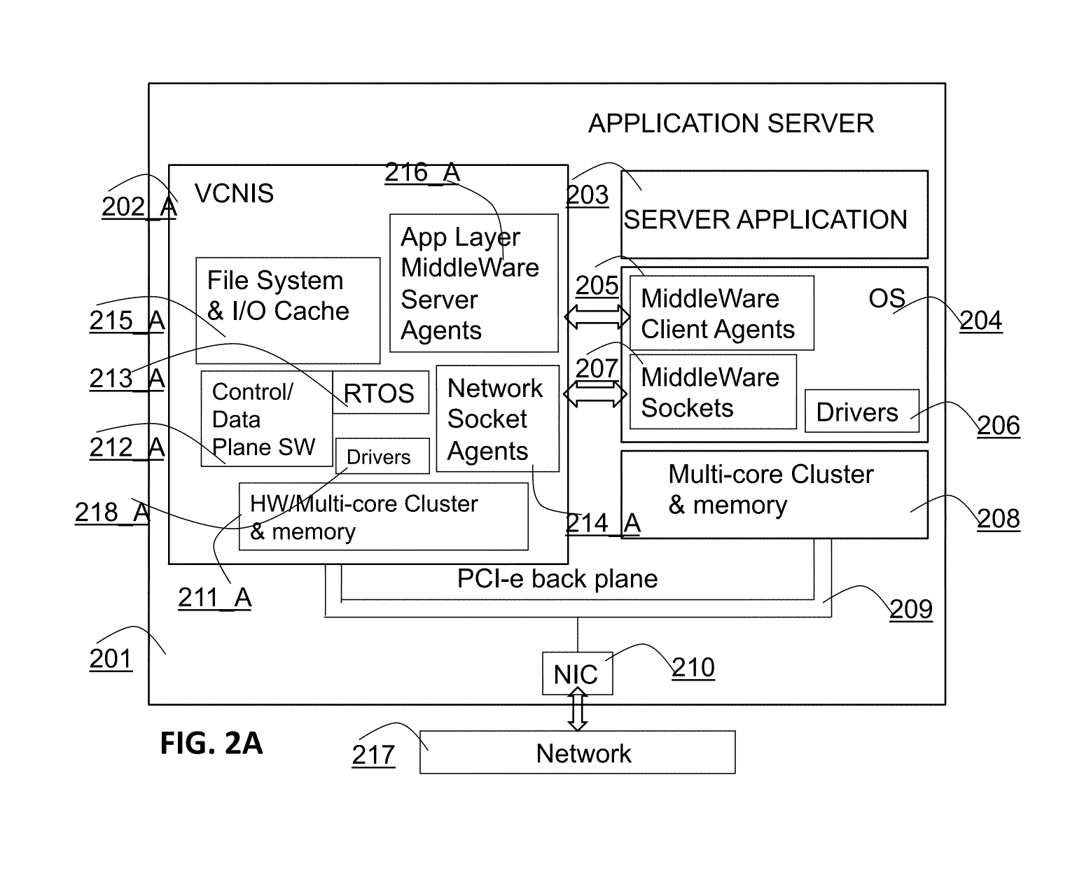

FIG. 2 illustrates an exemplary system level layout including virtualization and cloud security system (VCSS) architecture for use with the present system, according to one embodiment. An application server (201) is running a server application (203). The application server (201) has an operating system (OS) 204 as described above can be any one of commercial Windows, Linux and Unix multitasking operating system, drivers (206), middleware sockets (207) and middleware agents (205). The application server (201) is running a multi-core cluster (208) for server applications in its own software stacks in memory. The application server (201) when requires packet processing and security functions, those requests are intercepted and serviced by a virtualization and cloud security system VCSS (202). The services can communicate through middleware sockets (207) and agents (205). The middleware sockets (207) and agents (205) are in communication with the virtualization and cloud security system VCSS (202) according to the embodiments disclosed herein. The VCSS (202), according to one embodiment, includes a hardware blade having a multi-core processing cluster (211) plugged into the PCI-e backplane (209), and a minimal software stack including network socket agents (214), a real-time operating system (213), and a control/data plane software stack (212) running in memory. The VCSS (202) can also include security software support (215) and application layer server agents (216). Middleware sockets (207) and agents (205) can also communicate with application server agents (216) regarding service requests. The application server agents (216) communicate with the RTOS (213), control/data software stack (212) and network socket agent (214) to serve the request through HW/multi-core processing cluster through network interface cards through drivers (218) to access (NIC) 210 or via PCI-e backplane (209). The network interface card (NIC) 210 provides network (217) access. A more detailed description of the control/data plane software stack (212) and security software stack (215) follows below.

According to one embodiment, the present system provides an efficient implementation of fast path and slow path packet processing in control/data plane SW (212) to take advantage of the performance benefits provided by multi-core multiprocessing cluster (211). The present system includes a complete, comprehensive, and ready to use set of networking features including VLAN, Link Aggregation, GRE encapsulation, GTP and IP over IP tunneling, Layer 2/3 forwarding with virtual routing management, routing and virtual routing, network overlay termination, TCP termination, traffic management, service chaining, scaling to unlimited flows, Per Packet QoS (Quality-of-Service) and Filtering (ACLs) software functions in control/data plane SW (212), IPSec, SVTI, IKEv1 and IKEv2 for security functions in security SW (215). A more detailed description of SW (212) and SW (215) follows below.

The present system (102) runs on multi-core platforms (211) that have unified high-level APIs for interfacing with built-in services and functions in software (SW) (212) and hardware (HW) accelerators such as crypto engines or packet processing engines in multi-core cluster (211) and scales over different multi-core architectures, identical or non-identical as multi-core cluster (211) including low cost high volume hardware form factor, like PCI-e or ATCA configurations for enterprises and network equipment in data centers.

Hardware (HW) blade/multi-core cluster (211) provides hardware for the development of an intelligent virtualization and cloud security system, which includes hardware and software, that supports the growing demand for intelligent network/security acceleration and application offload for converged datacenter applications such as network, security, deep packet inspection (DPI), firewall, WAN Optimization, and application delivery (ADC) computing. HW/multi-core cluster (211) comprises a multi-core processor cluster (e.g., Freescale P4080QorIQ), DDR memory, flash memory, 10 Gb or 1 Gb network interfaces, mini SD/MMC card slot, a USB port, a serial console port, and a battery backed RTC and software drivers (218). Software configuring the hardware includes a real time OS (213), i.e., real-time Linux and drivers under Linux to control the hardware blocks and functions.

The multi-core cluster with security, network packet processing and services hardware acceleration unit in the multi-core cluster, in general, can handle appropriate functions for implementation of DPI/DDI (deep packet inspection/deep data inspection). In addition, acceleration can handle protocol processing, for example, including Ethernet, iSCSI, FC, FCoE, HTTP, SIP, and SNMP; content format includes XML, HTML/JavaScript; and pattern match includes IPS pattern and virus patterns. A more detailed description of security software (215) further follows below.

Other embodiments of the HW/multi-core cluster can include a different multi-core cluster, such as one from Cavium Networks to accelerate other emerging functions. For example, the Cavium Networks Nitrox family aids in implementing other security measures. While the depicted embodiment includes the PCI-e form factor, ATCA and blade center and other form factors can be used without departing from the spirit of the present system.

A real-time operating system (RTOS) (213) is an operating system (OS) intended to serve real-time application requests. Sometime it refers to Embedded Operating System. A key characteristic of a RTOS is the level of its consistency concerning the amount of time it takes to accept and complete an application's task; the variability is jitter. A hard real-time operating system has less jitter than a soft real-time operating system. The chief design goal is not high throughput, but rather a guarantee of a soft or hard performance category. A RTOS that can usually or generally meet a deadline is a soft real-time OS, but if it can meet a deadline deterministically, it is a hard real-time OS.

A real-time OS has an advanced algorithm for scheduling. Scheduler flexibility enables a wider, computer-system orchestration of process priorities, but a real-time OS is more frequently dedicated to a narrow set of applications. Key factors in a real-time OS are minimal interrupt latency and minimal thread switching latency. However, a real-time OS is valued more for how quickly or how predictably it can respond than for the amount of work it can perform in a given period of time. Examples of commercial real time OS include but not limited to VxWorks and commercial distribution of Open Source OS/RTOS like Linux or Embedded Linux from Windriver or Enea and Open Source OS/RTOS without commercial support and Windows Embedded from Microsoft. Some semiconductor companies also distribute their own version of real time Open Source Embedded Linux, for example, from Freescale and Cavium Networks. In addition to commercial products, there are also in house developed OS/RTOSs in various market segments.

According to one embodiment, one aspect of the present system includes offloading network packet processing into control/data plane software stack SW (212) from application server (201) in a data center. Yet another aspect of the present system includes offloading additional security software stacks SW (215) to support security and other application functions from application server in data center. The third party UTM (Unified Threat Management) or Enterprise Security stacks can be integrated and being run on SW (215). The description of UTM and Enterprise security stacks are explained below.

According to one embodiment, a security software stack, UTM (Unified Threat Management) or Enterprise Security Stack is provided by third party vendors. In addition to security software stacks running on the system (102) transparently, there are security related functions that can be accelerated by a multi-core processing cluster (211) contained in a hardware blade described below.

According to one embodiment, security software stack (215) comprises various software functions, with Table 1 illustrating examples. Table 1 provides descriptions for the modules.

TABLE 1

| Software Function | Description |
|---|---|
| Stateful Firewall with | Controlled access to network resources. |
| NAT | Network address translation. |
| IPSec VPN | Confidentiality, Authentication and Integrity |
| | for traffic between networks. Secure Remote |
| | Access. |
| SSLVPN | Secure Remote Access through a browser |
| IDS and IPS | Detect and prevent intrusions at L4-L7 and |
| | application level |
| Application Traffic | Detect and throttle less-priority application |
| Throttling | traffic (e.g., P2P, IM) |
| Network Anti-Virus | Stop virus infected payloads and malware from |
| | crossing the perimeter (e.g., emails, HTTP, FTP) |
| Application Firewall | Stop attacks/intrusions using deep data |
| (HTTP/SIP) | inspection of HTTP/SSL/compressed payloads |
| L4-L7 Load Balancer | Distribute load across multiple servers. |
| (ADC) | |
| Traffic Policing & | Enforce QoS policies on network/application |
| Shaping | traffic |
| Virtualization | Support multiple virtual security appliances |
| (Data Center) | within single hardware. Instances mapped to |
| | customers. |

Examples include stateful firewall with NAT (network address translation), IPSec VPN, SSLVPN, IDS (intrusion detection system) and IPS (intrusion prevention system), Application Traffic Throttling, Anti-Virus and Anti-Spyware, Application Firewall (HTTP and SIP), and packet processing functions in SW(212) and network agents (214) comprises L4-L7 load balancer, traffic policing and shaping, virtualization and cloud computing support, and support for web services, mobile devices, and social networking.

There are many third party commercial security software, for example, like Check Point Software Technologies and Trend Micro, can leverage not only the full security software stack accelerated by HW/Multi-core Cluster (211), control/data plane software (212), security software stack (215) and the rest of function blocks (215), (216), (214) but also seamlessly are integrated into (201) to protect the security measurements against any vulnerabilities and traffics in and out to system (201).

According to one embodiment, hardware acceleration of the security has deep packet inspection/deep data inspection (DDP/DDI). DDP/DDI enables increased deployment of advanced security functionality in system (102) with existing infrastructure without incurring new costs.

New or existing virtualization or non-virtualization security software or packet processing software can be downloaded from a remote server onto an existing user's system through secured links and remote call centers for existing customers. For new users, it is preinstalled and delivered with accompanying hardware. Once the software is loaded upon initial power up, the customers' applications are downloaded on top of software on various hardware modules depending on the security applications.

Application layer server agents (216) serve the different applications which are sent by the middleware client agents (205) and (207) to the application server agents (216) on behalf of application server (201) to serve those requests. The application layer server agent (216) is used by the system 102 to perform existing and new advanced security functions, which will be emerged in the future. In addition, the new real time intensive tasks, functions, applications or services can be served by system 102 on the behalf of application server 101 to serve those requests. Once the services are requested, the application server system (201) can activate and transfer through network interface (210) or PCI-e (209) through control from middleware client agents (205) and middleware sockets (207) to application layer server agents (216) to serve on behalf of application server 201 under services from RCM application (302) in RCM software infrastructure 301 defined as follows. Once the new applications (302) require services, the new applications will be delivered to the app layer server agent (216) via the are software interfaces, (303), (305), (306), and (307) based on the handshaking mechanism defined in between (205) and (216) and return a desired result through software instructions (207) and interface (210) or (209) indicative of successful completion of the service to the first system.

According to one embodiment, another aspect of the present system includes providing virtualization of security and network packet processing. A virtualization security platform, including combination of hardware multi-core cluster (211) and software platform, built-in on top of the hardware blades further described below, is the foundation of cloud computing security platform and includes additional software virtual machines running in system to offload network packet processing and security virtual machines from a virtualized server of system (101) into (102). The network packet processing, network services and security functions are then, instead, handled by packet processing software virtual machines and security software virtual machines as part of the present system, according to one embodiment.

The systems described herein might provide for integration of virtual and physical real time multi-core clusters systems into physical server or server virtualization environment so that virtual machine awareness, implementation of security policies on various virtual machine levels or non-virtualized system levels, visibility and control of virtual machines, security and packet processing provided by a combination of virtualized software appliances and non-virtualized security software and packet processing software can be achieved. In addition, the end-point data protection at level of standard computer server or host, which is the source of data generation, acceleration of network traffic and security functions, open software framework for third party security software vendors can be offloaded into present system by elimination of host performance penalties, and/or data security.

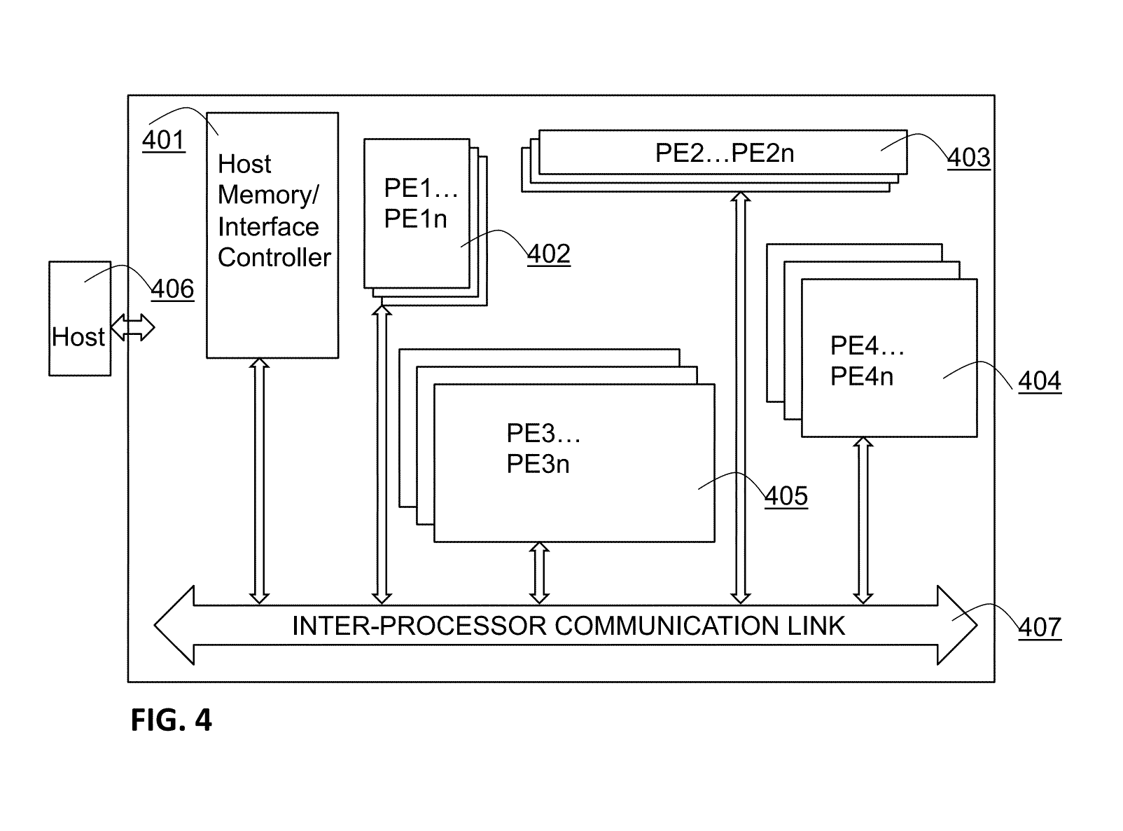

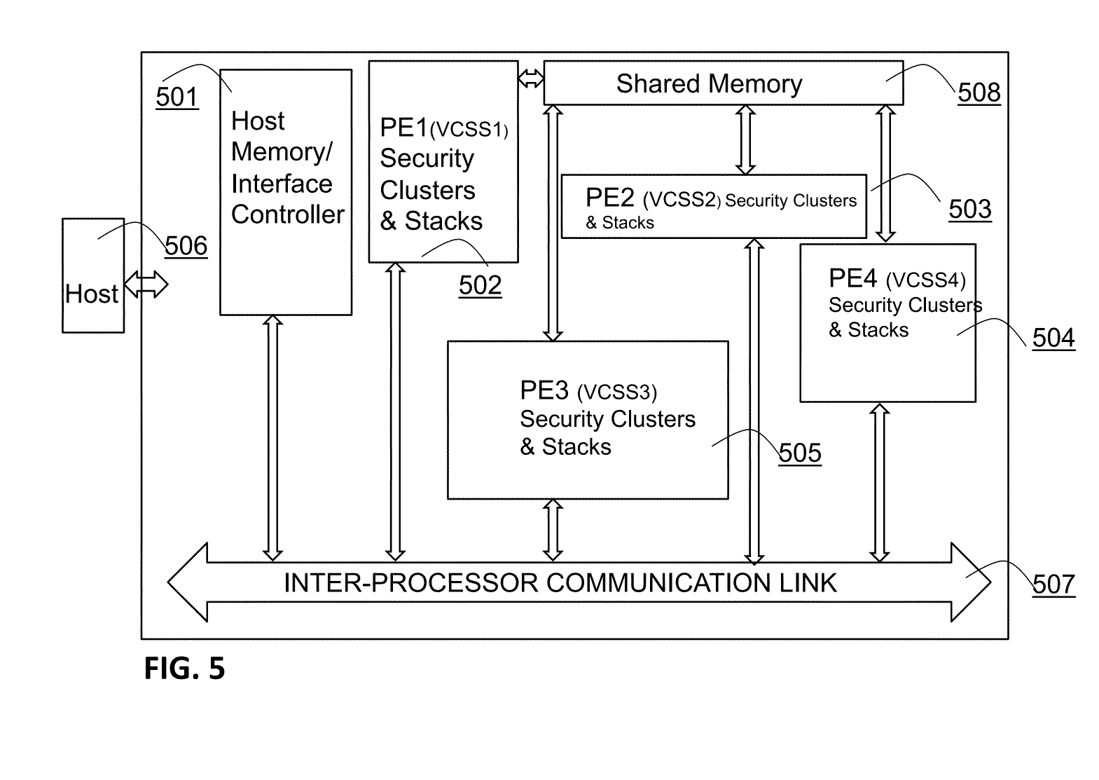

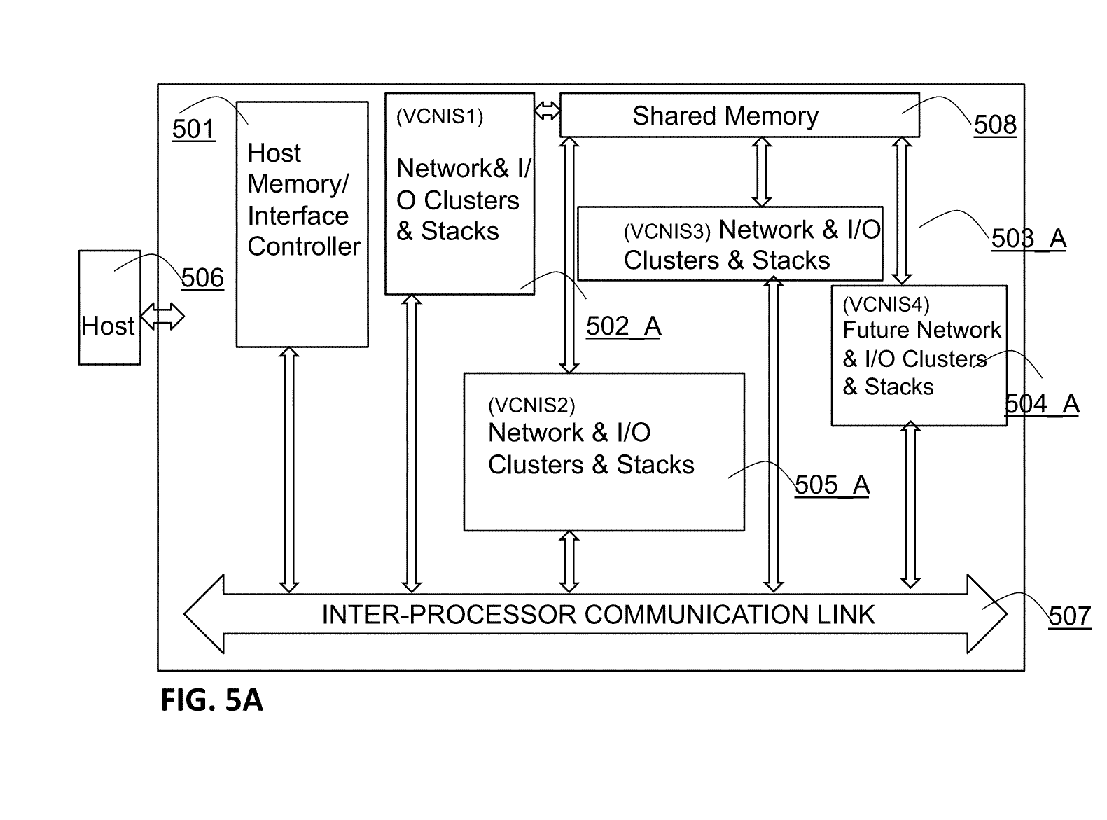

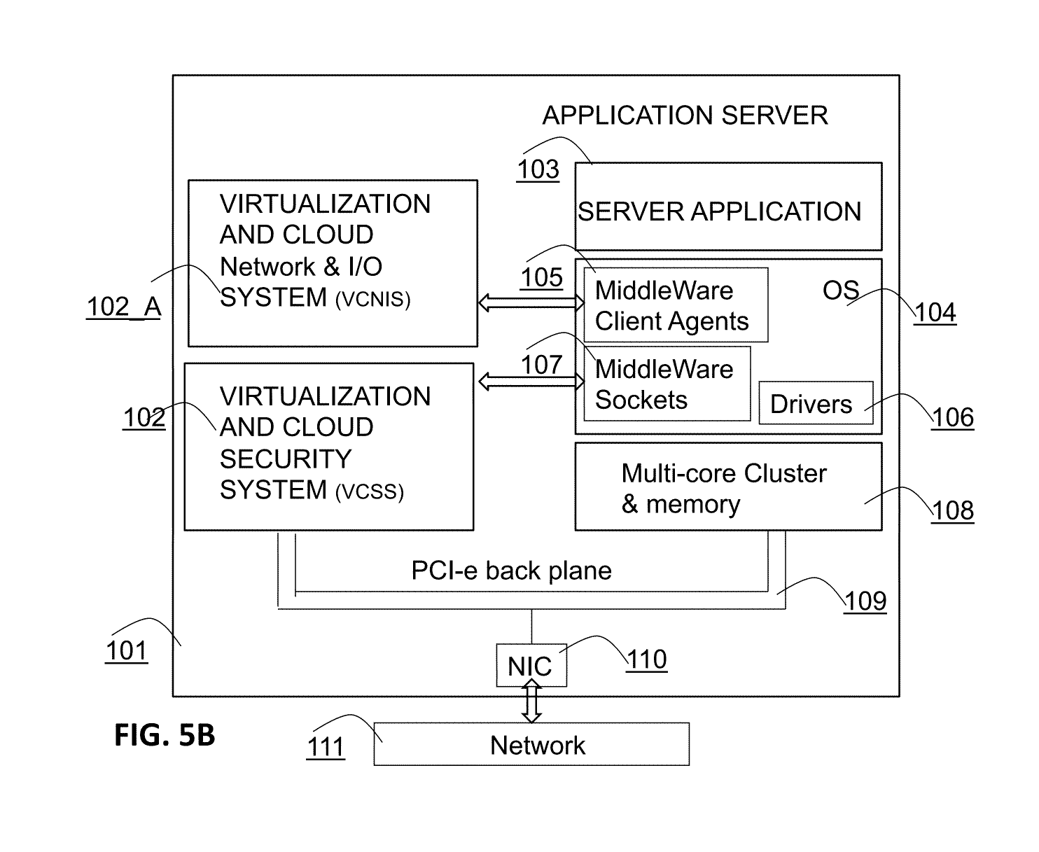

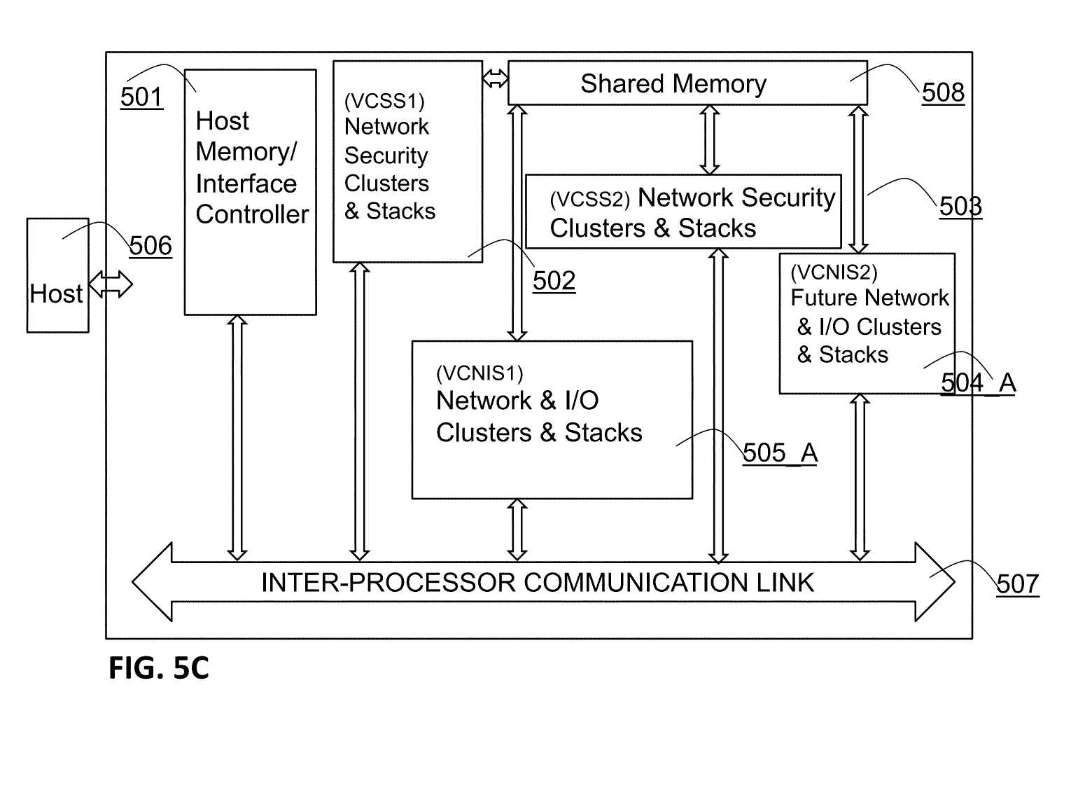

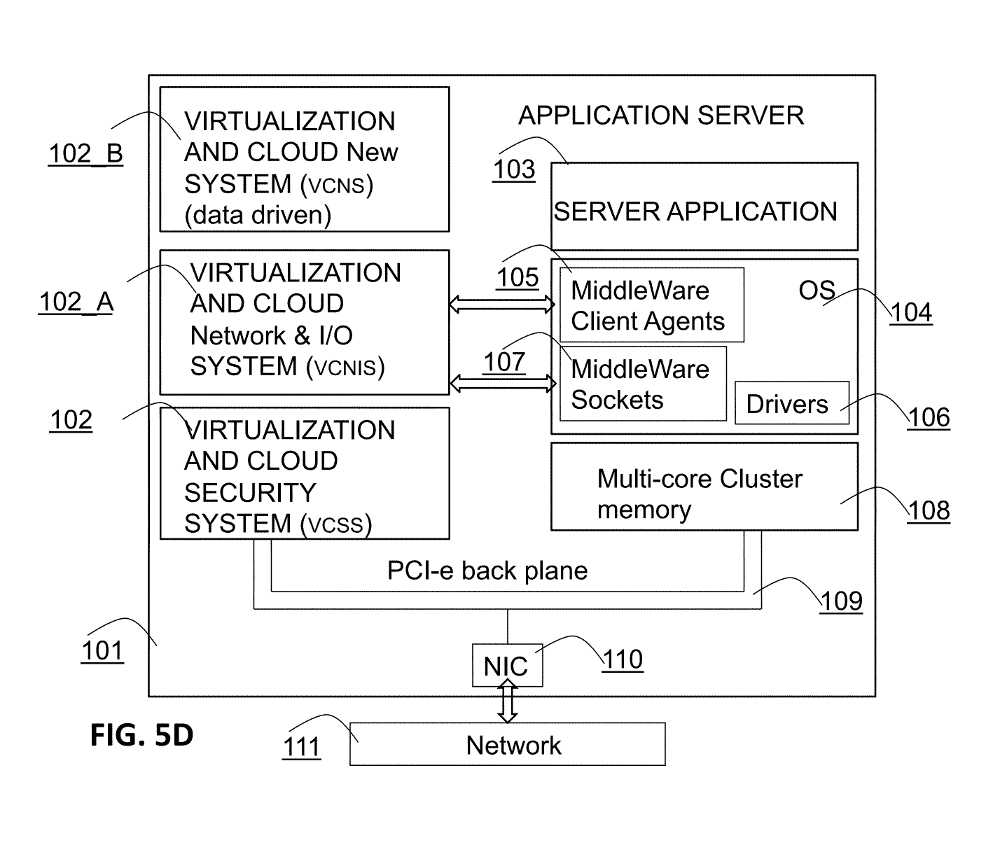

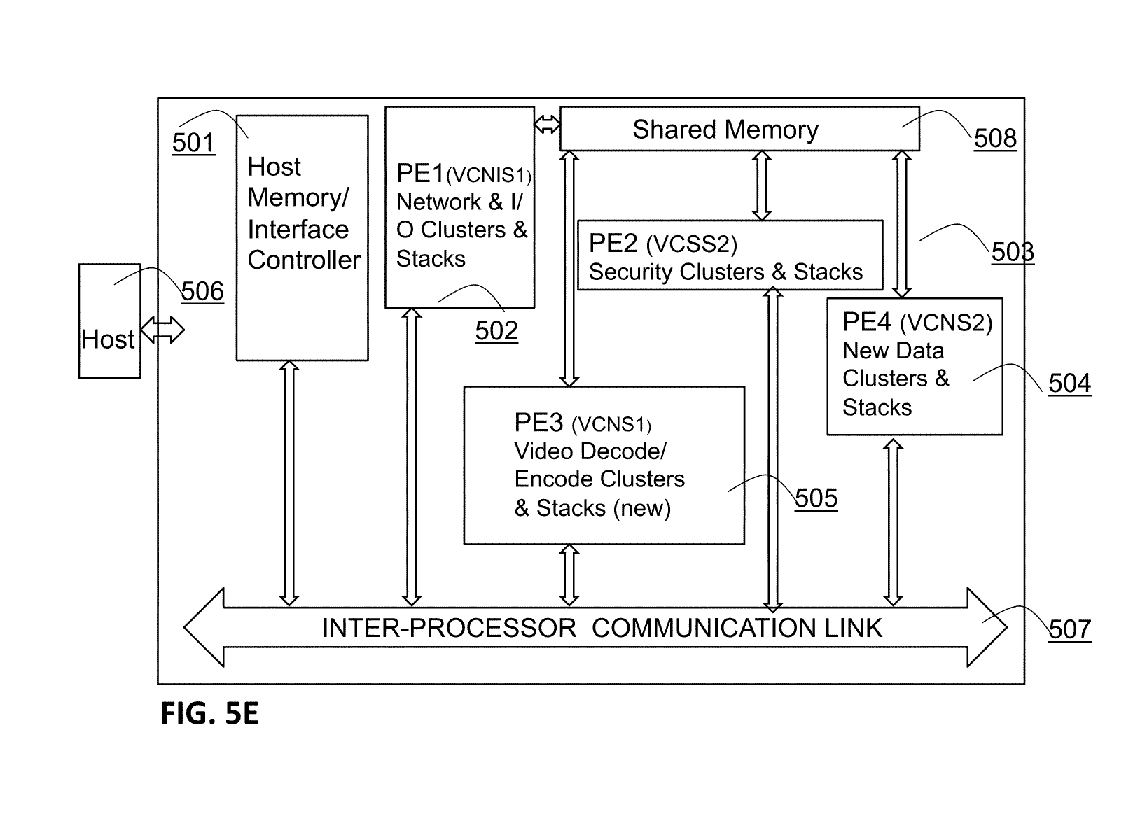

The present system includes distributed real-time computing capabilities integrated in a standard server platform. Distributed real time computing clusters, expanded from vertically and horizontally according to one embodiment, can be thought of as server farms, which have heterogeneous multi-core processing clusters, and server farm resources can be increased on-demand when workloads are increased. Server farm resources can be quickly activated, de-activated, upgraded or deployed. According to the embodiments, FIG. 4 and FIG. 5 illustrates the example of present system with expansion of distributed real time computing clusters.

Performance scalability of the present system is two-dimensional: horizontal and vertical. The same or identical multi-core cluster function can be expanded vertically by a homogeneous architecture, and different or non-identical multi-core function can be expanded horizontal by heterogeneous architecture. Homogeneous and heterogeneous architectures are explained below in greater detail.

The present system provides for power consumption optimization. An application load driven approach provides the best power consumption utilization. Resources are enabled and disabled based on demand to follow a green energy policy.

A software programming model of the present system provides that not all existing applications are required to be rewritten and that all emerging new applications can be running transparently by using exiting APIs (application programming interface) call from existing operating systems or expanded APIs call from library supplied by third party software vendors

A “systems of system” and method for virtualization and cloud network and I/O (input and output) system are disclosed. According to one embodiment, FIG. 1A illustrates a system (101) comprising a first multi-core processing cluster (108), which is controlled by multi-tasking OS (104) in communication with a network interface cards (110) or via PCI-e backplane (109) and software instructions (105) to the system VCNIS (102_A), when installed, through interface. When the software instructions (105) are executed by the second system with non-identical or identical multi-core processing cluster (211_A) inside of system (102_A), which is controlled by real time operating system RTOS (213_A) inside of system (102_A), they cause the second non-identical or identical multi-core processing cluster (211_A) to receive a request for a service, create a new or invoke an existing software functions to service the request, and return a desired result through software instructions (107) and interface (110) or (109) indicative of successful completion of the service to the first system.

According to one embodiment, the present system is fully integrated with a control/data plane SW (212_A) of operating system RTOS (213_A) for maximum reuse of software, simplified integration and hiding of multi-core design complexities. The present system (102_A) runs on multi-core clusters platforms (211_A) with unified high-level APIs for interfacing with built-in network services and functions in software (SW) (212_A) and hardware (HW) accelerators such as packet processing engines, virtual address mapping/management, and/or (SW)(215_A) file system, I/O data cache, I/O software control functions and other accelerators in multi-core cluster (211_A) and scales over different multi-core architectures, identical or non-identical as multi-core cluster (211_A) including low cost high volume hardware form factor, like PCI-e, or ATCA configurations for enterprises and network equipment in data centers. The present system provides an open architecture to ease integration.

According to one embodiment, one aspect of the present system includes offloading network services processing and functions into control/data plane software stack SW (212_A) from application server (201) in a data center. Yet another aspect of the present system includes offloading additional file system software and other I/O data cache, control function stacks SW (215_A) to support I/O application functions and stacks from application server in data center. The third party network and I/O stacks can be integrated and being run on SW (212_A) and SW (215_A). The description of SW (212_A) and (SW) (215_A) is further explained below.

According to one embodiment, the present system provides an efficient implementation of fast path and slow path network services processing in control/data plane SW (212_A) to take advantage of the performance benefits provided by multi-core multiprocessing cluster (211_A). The present system includes a complete, comprehensive, and ready to use set of networking features including but not limited to VLAN, Link Aggregation, GRE encapsulation, GTP and IP over IP tunneling, Layer 2/3 forwarding with virtual routing management, routing and virtual routing, network overlay termination, TCP termination, traffic management, service chaining, scaling to unlimited flows, Per Packet QoS (Quality-of-Service) and Filtering (ACLs), virtual address mapping functions and buffer management and software functions like network services functions in control/data plane SW (212_A). More detailed description of SW (215_A) follows below.

SW (215_A) contains file system, I/O data cache and I/O software control functions. A file system in computing system is a method for storing and organizing computer files and the data they contain to make it easy to find and access or read them. File systems may use a data storage device such as a hard disk, CD-ROM or latest SSD (solid state disk) and NVM (non-volatile memory) technology to store the data. File systems involve maintaining and managing the physical location of the files, or they may be virtual and exist only as an access method for virtual data or for data over a network (e.g. NFS). The type of file systems includes but not limited to local file system, shared file system (SAN file system and cluster file system), network file system (distributed file system and distributed parallel system) and object file system. More formally, a file system is a set of abstract data types that are implemented for the storage, hierarchical organization, manipulation, navigation, access, and retrieval of data. Object file system is an approach to storage where data is combined with rich metadata in order to preserve information about both the context and the content of the data. The metadata present in object file system gives users the context and content information they need to properly manage and access unstructured data. They can easily search for data without knowing specific filenames, dates or traditional file designations. They can also use the metadata to apply policies for routing, retention and deletion as well as automate storage management. A more detailed description of the cache will be explained follows below.

A cache is a temporary storage area that keeps data available for fast and easy access. For example, the files you automatically request by looking at a web page are stored on your hard disk in a cache subdirectory under your browser's directory. When you return to a page that you have recently viewed, the browser can get those files from the cache rather than from the original server, saving you time and saving the network the burden of additional traffic.

Caching is the process of storing data in a cache. The data held in a cache is almost always a copy of data that exists somewhere else. In a system-wide I/O acceleration cache, the information cached is often the most active disk blocks for the particular physical or virtual system whose performance we are trying to improve. The cache itself resides closer to the system using it, typically on a high-performance media, while the original copy still resides on the system's primary storage facility.

Caching approaches always cache data to improve access upon subsequent accesses. Caches are therefore differentiated by their behavior handling updates (WRITES) to the cache.

All caches have one additional similarity; they all are of finite size and therefore need to manage their limited ability to store active data. All caches have replacement algorithms that determine when more recently accessed data should be retained and therefore manage when older data can be safely released from the cache and the space reclaimed.

In short, when caching is a good option, caching storage data into memory is extremely effective as it moves frequently accessed data closer to the CPU, on much faster media than hard disks. The media used as mechanisms to implement I/O data cache can be DRAM, SRAM, SSD (solid state disk) or newer NVM (non-volatile memory) technologies.

According to one embodiment, another aspect of the present system includes providing virtualization of network functions, network services, file system and I/O data cache and software control functions. A virtualization of network services, file system and I/O software control functions platform, including combination of hardware multi-core cluster (211_A) and software platform, built-in on top of the hardware blades further described below, is the foundation of cloud computing platform and includes additional software virtual machines running in system to offload network functions, network services processing and I/O functions related virtual machines from a virtualized server of system (101) into (102_A). The network functions, services processing and I/O functions are then, instead, handled by network processing software virtual machines and I/O file system and I/O control software virtual machines as part of the present system, according to one embodiment listed in FIG. 6A and described in the later section.

Application layer server agents (216_A) serve the different applications which are sent by the middleware client agents (205) and (207) to the application server agents (216) on behalf of application server (201) to serve those requests. The application layer server agent (216_A) is used by the system 102_A to perform new advanced network applications stack, network services, file system, I/O data cache and I/O control functions and stack which will be emerged in the future. In addition, the new real time intensive tasks, functions or services can be served by system 102_A on the behalf of application server 101 to serve those requests. Once the services are requested, the application server system (201) can activate and transfer through network interface (210) or PCI-e (209) through control from middleware client agents (205) and middleware sockets (207) to application layer server agents (216_A) to serve on behalf of application server 201 under services from RCM application (302) in RCM software infrastructure 301 defined as follows.

Once the new applications (302) require services, the new applications will be delivered to the app layer server agent (216_A) via the interface based on the handshaking mechanism defined in between (205) and (216_A) and return a desired result through software instructions (207) and interface (210) or (209) indicative of successful completion of the service to the first system.

New or existing virtualization or non-virtualization I/O file system, I/O control software and I/O data cache functions or network services processing software is downloaded from a remote server or storage onto an existing user's system through secured links and remote call centers for existing customers. For new users, it is preinstalled and delivered with accompanying hardware. Once the software is loaded upon initial power up, the customers' applications are downloaded on top of software on various hardware modules depending on the network functions, network services and I/O applications.

According to one embodiment, I/O file system and/or I/O data cache, and/or other I/O control functions software stacks can be provided by third party vendors. In addition to file system and I/O data cache and I/O software stacks running on the system (102) transparently, there are other I/O related functions that can be accelerated by a multi-core processing cluster (211_A) contained in a hardware blade described below.

The systems described herein might provide for integration of virtual and physical real time multi-core clusters systems into standard physical server or server virtualization environment to achieve virtual machine awareness, implementation of security policies on various virtual machine levels or non-virtualized system levels, visibility and control of virtual machines, security and packet processing, non-virtualized and virtualized network services, I/O software control functions and file system software provided by a combination of virtualized software appliances (multiple virtual machines), software stacks and expandable hardware infrastructure as total system framework to form an open framework for the third party vendors of security, network, file system and I/O control software to accelerate their software applications.

The present system includes distributed real-time computing capabilities integrated in a standard server platform. Distributed real time computing clusters, expanded from vertically and horizontally according to one embodiment, can be thought of as server farms, which have heterogeneous multi-core processing clusters, and server farm resources can be increased on-demand when workloads are increased. Server farm resources can be quickly activated, de-activated, upgraded or deployed. According to the embodiments, FIG. 4 and FIG. 5A illustrates the example of present system with expansion of distributed real time computing clusters.

Performance scalability of the present system is two-dimensional: horizontal and vertical. The same or identical multi-core cluster function can be expanded vertically by a homogeneous architecture, and different or non-identical multi-core function can be expanded horizontal by heterogeneous architecture. Homogeneous and heterogeneous architectures are explained below in greater detail.

The present system provides for power consumption optimization. An application load driven approach provides the best power consumption utilization. Resources are enabled and disabled based on demand to follow a green energy policy.

A software programming model of the present system provides that all existing applications are not required to be rewritten and that all emerging new applications can be running transparently by using existing APIs (application programming interface) call from existing operating systems or expanded APIs call from library supplied by third party software vendors

FIG. 2A illustrates an exemplary system level layout including virtualization and cloud network and I/O system (VCNIS) architecture for use with the present system, according to one embodiment. An application server (201) is running a server application (203). The application server 201 has an operating system (OS) 204 as described above can be any one of commercial Windows, Linux and Unix multitasking operating system, drivers (206), middleware sockets (207) and middleware agents (205). The application server (201) is running a multi-core cluster (208) for server applications in memory. The application server (201) when requires network services processing, file system and I/O related functions, those requests are intercepted and serviced by a virtualization and cloud network and I/O system (VCNIS) (202_A). The services can communicate through middleware sockets (207) and agents (205). The middleware sockets (207) and agents (205) are in communication with the virtualization and cloud network and I/O system VCNIS (202_A) according to the embodiments disclosed herein. The VCNIS (202_A), according to one embodiment, includes a hardware blade having a multi-core processing cluster (211_A) plugged into the PCI-e backplane (209), and a minimal software stack including network socket agents (214_A), a real-time operating system (213_A), and a control/data plane software stack (212_A). The VCNIS (202_A) can also include file system and I/O data cache, I/O control software support (215_A) and application layer server agents (216_A). Middleware sockets (207) and agents (205) can also communicate with application server agents (216_A) regarding service requests. The application server agents (216_A) communicate with the RTOS (213_A), control/data software stack (212_A) and network socket agent (214_A) to serve the request through HW/multi-core processing cluster through network interface cards (NIC) 210 or via PCI-e backplane (209). The network interface card (NIC) 210 provides network (217) access. A more detailed description of the control/data plane software stack (212_A) and file system and I/O software stack (215_A) follows below.

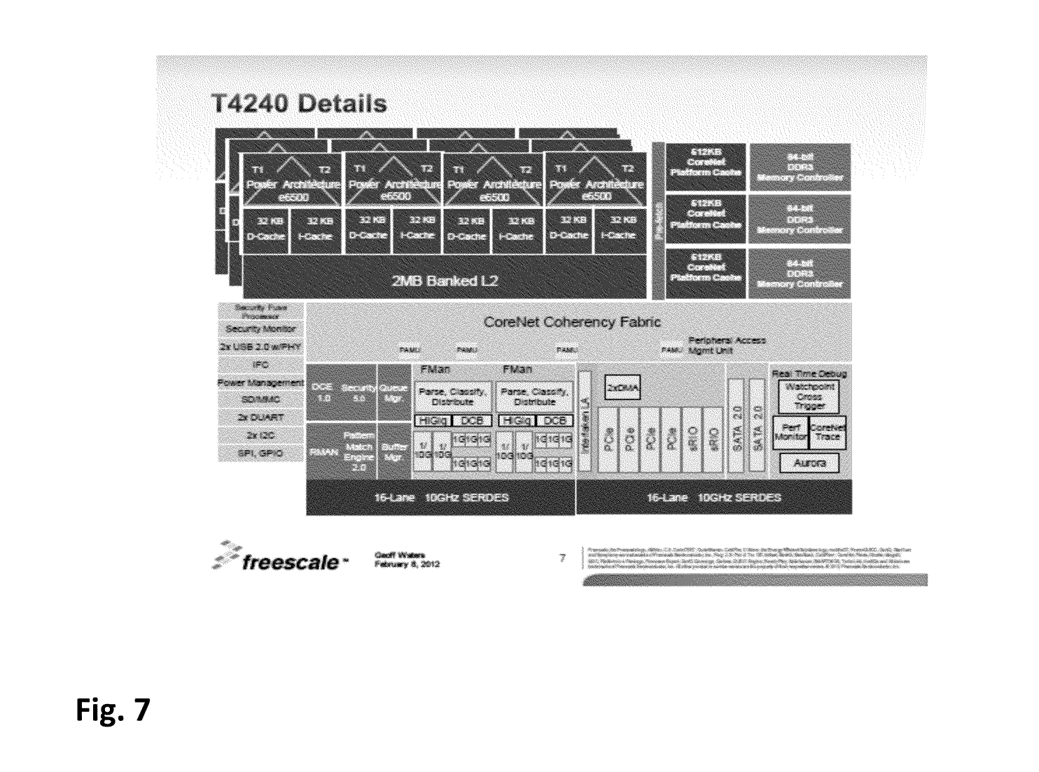

Hardware (HW) blade/multi-core cluster (211_A) provides hardware for the development of an intelligent virtualization and cloud network and I/O system, which includes hardware infrastructure and software platform, that supports the growing demand for network functions, intelligent network services, file system and I/O data and control functions acceleration and application offload for converged datacenter applications such as network services, file system, storage, WAN Optimization, and application delivery (ADC) computing. HW/multi-core cluster & memory 211_A comprises a multi-core processor cluster (e.g., Freescale P4080QorIQ), DDR memory, flash memory, 10 Gb or 1 Gb network interfaces, mini SD/MMC card slot, a USB port, a serial console port, and a battery backed RTC. Software configuring the hardware includes a real time OS (213_A), i.e., real-time Linux and drivers (218_A) under Linux to control the hardware blocks and functions. A newer multi-core cluster (e.g. Freescale T4240) can be another example shown in FIG. 7 can be used for the same purpose as Freescale P4080 QorIQ.

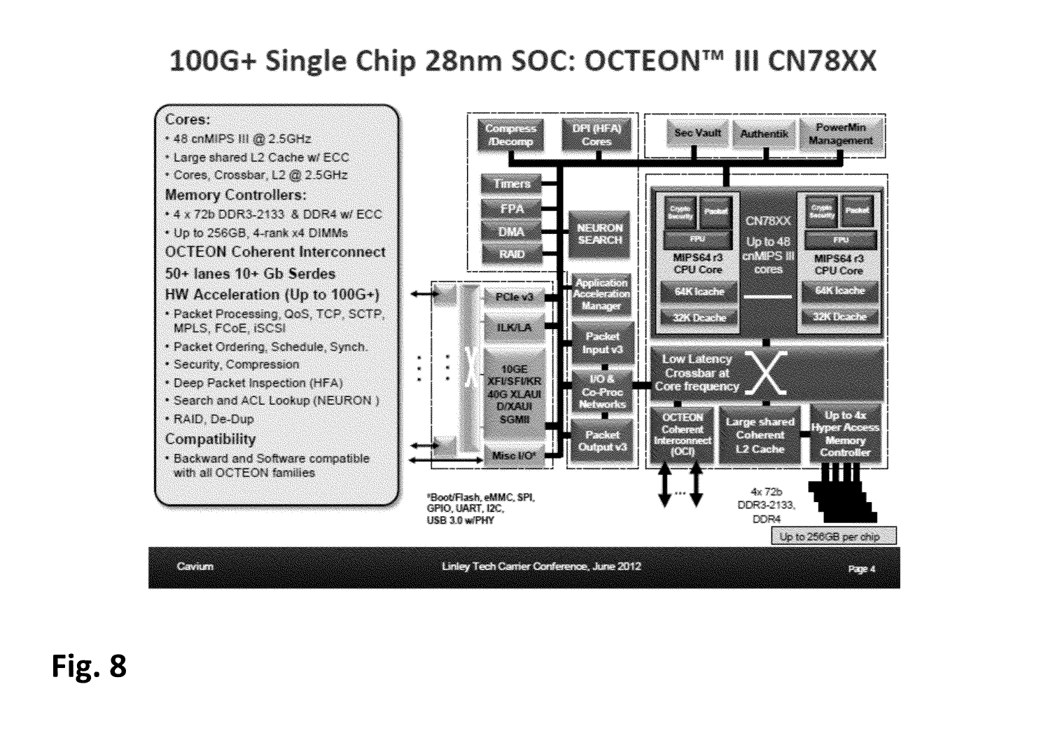

Other embodiments of the HW/multi-core cluster can include a different multi-core cluster, such as one from Cavium Networks (FIG. 8) to accelerate other emerging functions. For example, the Cavium Networks Nitrox family aids in implementing other security measures. While the depicted embodiment includes the PCI-e form factor, ATCA and blade center and other form factors can be used without departing from the spirit of the present system.

A real-time operating system (RTOS) (213_A) is an operating system (OS) intended to serve real-time application requests. Sometime RTOS refers to Embedded Operating System. A key characteristic of a RTOS is the level of its consistency concerning the amount of time it takes to accept and complete an application's task; the variability is jitter. A hard real-time operating system has less jitter than a soft real-time operating system. The chief design goal is not high throughput, but rather a guarantee of a soft or hard performance category. A RTOS that can usually or generally meet a deadline is a soft real-time OS, but if it can meet a deadline deterministically, it is a hard real-time OS. A real-time OS has an advanced algorithm for scheduling. Scheduler flexibility enables a wider, computer-system orchestration of process priorities, but a real-time OS is more frequently dedicated to a narrow set of applications. Key factors in a real-time OS are minimal interrupt latency and minimal thread switching latency. However, a real-time OS is valued more for how quickly or how predictably it can respond than for the amount of work it can perform in a given period of time. Examples of commercial real time OS include but not limited to VxWorks and commercial distribution of Open Source OS/RTOS like Linux or Embedded Linux from Windriver (Intel company) or Enea and Open Source OS/RTOS without commercial support and Windows Embedded from Microsoft. Some semiconductor companies also distribute their own version of real time Open Source Embedded Linux, for example, from Freescale and Cavium Networks. In addition to commercial products, there are also in house developed OS/RTOSs in various market segments.

Application layer server agents (216_A) serve the different applications which are sent by the middleware client agents (205) and (207) to the application server agents (216_A) on behalf of application server (201) to serve those requests. The application layer server agent (216_A) is used by the system 102 to perform new advanced network and I/O functions which will be emerged in the future. In addition, the new real time intensive tasks, functions or services can be served by system 102_A on the behalf of application server 101 to serve those requests. If the applications (302) require the new services from (202_A), the new services for RCM software infrastructure 301 defined as follows. Once the new applications (302) require new services from (202_A), the new services are requested. The application server system (201) can activate and transfer through network interface (210) or PCI-e (209) through control from middleware client agents (205) and middleware sockets (207) to application layer server agents (216_A) to load the new services through network interface (210) from remote storage system or from (208) into (218_A) from (201) on behalf of application server 201 under control from RCM application (302) and RCM software infrastructure 301. Once the new services are delivered to the application layer server agent (216_A) via the network interface (210) or (208) based on the handshaking mechanism defined in among (205), (207) and (216_A) loaded into (211_A) and return a desired result through software instructions (207) and interface (210) or (209) indicative of successful completion of the service to the application server system (201).

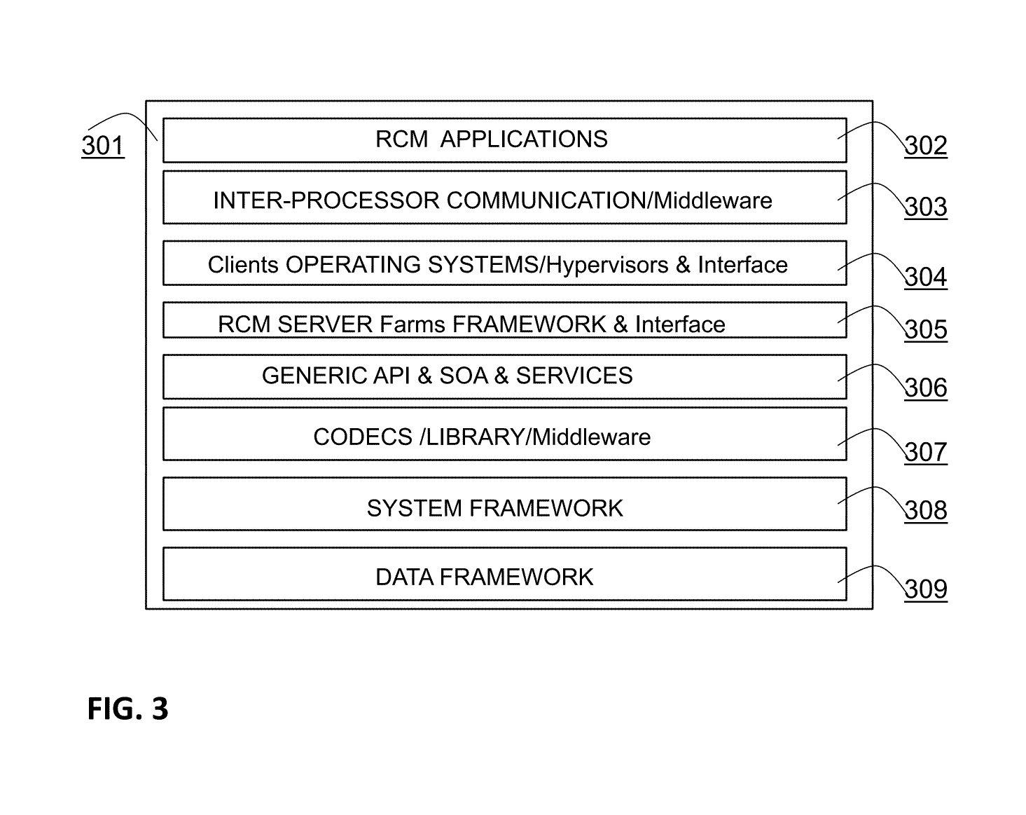

FIG. 3 illustrates an exemplary software infrastructure expanded from (203), (204), (205), (206) and (207) for use with the present system, according to one embodiment. An exemplary software infrastructure 301 includes support for rich content media (RCM) applications 302. The rich content media applications 302 can include security, video, imaging, audio and any combination of media (examples described herein) and embodiments described herein.

The infrastructure 301 includes inter-processor communication/middleware 303 and support of various operating systems and/or hypervisors and interfaces 304. The infrastructure 301 includes RCM framework 305, generic APIs, services, and SOAs 306, support for various codecs (compression/decompression) and library expansion or middleware 307, a system framework 308 and a data framework 309.

Application framework 302 can interface to any rich content multimedia applications from various sources through APIs (application programming interface) SOA, or services through 306. Applications can be accelerated and expanded from one or more groups of service including network packet processing, security, security decryption/encryption, video compression/decompression, audio compression/decompression, imaging compression/decompression defined as text, audio, or video and graphics with a combination of decode and encode for remote or local sources. Encode in this case is compression technology and decode is decompression technology. The content source can be from local devices run in the server, PC or other mobile device. The content source can be remote through a LAN, WAN run from servers, web servers, application servers, data base servers in data center, or any cloud computing applications through internet access.

Newer applications, e.g., pattern recognition, can be expanded from the basic text, audio, video and imaging to run local or remote with special algorithms to encode and decode. In other words, the application framework 302 can be expanded to support the pattern recognition applications with special algorithms to compress and decompress from local servers, PCs or mobile devices or from remote cloud computing resources from internet remotely.

Inter-processor communication and middleware 303 occurs over multi-core clusters, operating systems, system interconnects and hypervisors. Inter-processor communication and middleware 303 module resides on each multi-core cluster can be used as messages communication among all different multi-core clusters identical or non-identical and middleware to communicate among each multi-core clusters. Highlights of 303 include communications (IPC) through distributed messaging passing; OS, platform and interconnect independent; transparency to system scale and reconfigure without modifying codes; multiple producers and consumers; distributed inter-processing communication technology; messages based protocol or data centric distributed data services; transparent application to application connection; reliable delivery communication model; operating system independent (Windows, Linux and Unix); hardware platform independent (RISC, DSP or others).

An exemplary embodiment includes DDS as explained below for the inter-processor communication. Communication standard data distribution service (DDS), enables system scalability that can support a spectrum of communication requirements, from peer to peer to vast swarms of fixed and mobile devices that have intermittent and highly variable communications profiles.

The DDS standard is particularly well-suited to distributing real-time data for logging as well as for general distributed application development and system integration. DDS specifies an API designed for enabling real-time data distribution. It uses publish-subscribe communication model and supports both messaging and data-object centric data models. DDS offers several enhanced capabilities with respect to content-based filtering and transformation, per dataflow connectivity monitoring, redundancy, replication, delivery effort and ordering, as well as spontaneous discovery. Furthermore, DDS offers new capabilities with respect to data-object lifecycle management, best-effort and predictable delivery, delivery ordering, resource management, and status notifications.

RCM framework 305 provides core services (SOA) (service oriented architecture) for communications among applications running on 203 applications with enterprise SOA or spread across multiple real time based operating systems and multi-core clusters SOA based applications running in memory on the present system. RCM framework 305 uses communications and middleware (303) to convert and communicate requests and messages among multiple consumers and producers through distributed messaging passing or data centric DDS based distributed messages communication to provide SOA services to different multi-core clusters in system. It is OS, platform and interconnect independent, transparent to system scale and can reconfigure without modifying codes.

System framework 308 includes local hardware multi-core clusters and resource scheduler and management, provisioning, configuring, relocation and remote access. The multiple real-time OS configuration can support AMP (asymmetric real time multi-core multiprocessing; i.e., heterogeneous processing wherein different operating systems control different hardware multi-core clusters), SMP (symmetric real time multi-core multiprocessing; i.e., homogeneous processing wherein the same type or identical hardware multi-core clusters run under the same operating system), controlling inter-process communication between operating systems, scheduling global resources and management of clusters, handling global and local resource loading, statistics and migration, as well as providing a virtualization infrastructure interface and management of multi-core clusters.

IP-based network applications can be partitioned into three basic elements: data plane, control plane and management plane.

The data plane is a subsystem of a network node that receives and sends packets from an interface, processes them in some way required by the applicable protocol, and delivers, drops, or forwards them as appropriate. For routing functions, it consists of a set of procedures (algorithms) that a router uses to make a forwarding decision on a packet. The algorithms define the information from a received packet to find a particular entry in its forwarding table, as well as the exact procedures that the routing function uses for finding the entry. It offloads packet forwarding from higher-level multi-core clusters. For most or all of the packets it receives and that are not addressed for delivery to the node itself, it performs all required processing. Similarly, for IPSec functions, a security gateway checks if the security association is valid for an incoming flow and if so, the data plane locally finds information to apply security association to a packet.

The control plane maintains information that can be used to change data used by the data plane. Maintaining this information requires handling complex signaling protocols. Implementing these protocols in data plane would lead to poor forwarding performance. A common way to manage these protocols is to let the data plane detect incoming signaling packets and locally forward them to control plane. Control plane signaling protocols can update data plane information and inject outgoing signaling packets in data plane. This architecture works because signaling traffic is a very small part of the global traffic. For routing functions, the control plane consists of one or more routing protocols that provide exchange of routing information between routers, as well as the procedures (algorithms) that a router uses to convert this information into the forwarding table. As soon as the data plane detects a routing packet, it forwards it to the control plane to let routing protocol compute new routes, add or delete routes. Forwarding tables are updated with this new information. When a routing protocol has to send a packet, it is injected in the data plane to be sent in the outgoing flow. For IPSec security functions, signaling protocols for key exchange management such as IKE or IKEv2 are located in the control plane. Incoming IKE packets are locally forwarded to control plane. When keys are renewed, security associations located in the data plane are updated by control plane. Outgoing IKE packets are injected in the data plane to be sent in the outgoing flow.

To provide a complete solution for next generation network applications and services, network packet processing today is much more complex when compared to a simple TCP/IP stack at the inception of the Internet. Refer to the description herein for the definition of control plane and data plane. High speed processing handles simple processing in a fast path or data plane. The software stack is running on the data plane which is done by multiple CPU cores to handle the data plane tasks. Complex processing is delegated to the slow path or control plane. The fast path typically is expected to integrate a large number of protocols and be designed so that adding a new protocol will not penalize the performance of the whole system.

A common network use case is made of VPN/IPSec tunnels and that aggregates Gbps of HTTP, video and audio streams. Since the L3/L7 protocols are encrypted, a data plane design which is only made of flow affinities cannot assign a specific core to each of them. It is only possible once all the pre-IPSec-processing and decryption of the payloads are complete. At each level, exceptions can happen if the packet cannot be handled at the fast path level. Implementing an additional protocol adds tests in the initial call flow and requires more instructions. The overall performance will be lower. However, there are some software design rules that can lead to an excellent trade-off between features and performance.

The management plane provides an administrative interface into the overall system. It contains processes that support operational administration, management or configuration/provisioning actions such as facilities for supporting statistics collection and aggregation, support for the implementation of management protocols, and also provides a command line interface (CLI) and/or a graphical user configuration interface, such as via a Web interface or traditional SNMP management software. More sophisticated solutions based on XML can also be implemented.

The present system supports rich content multimedia (RCM) applications. Because rich content multimedia applications consume and produce tremendous different type of data, it is very important to have a distributed data framework to be able to process, manipulate, transmit/receive, and retrieve/store all various data, for example, data, voice, audio and video today. The present system also supports other rich data types listed below and is not limited to imaging, pattern recognition, speech recognition and animation. The data type can be expanded from the basic type format and become a composition data type of multiple intrinsic data types. Where complex data type transmission and receiving requires data streams to be compressed into some certain industry standard or proprietary algorithms before transmission, the receiving end point will decompress or reconstruct the data back into its original data types and that can be done using real-time processes.

For example, video data, after being compressed with certain algorithms, can become a different data type, i.e., MPEG4 and H.264. The same applies for the audio data. Therefore, certain types of data synchronization mechanisms are required to support data reconstruction at destination.

In some traditional multimedia systems, the data types are limited by what can be efficiently processed. For example, data types might be limited to audio, video or graphics, from a single local content source to a single content destination, simple audio/video synchronization, a single content stream, etc. Typically, applications are mainly decoding, do not operate in real-time, are not interactive, do not have require synchronization at the data source, don't have reconstruction at the data destination, and don't have data type composition or data type protection. However using the present system, it can be possible to handle rich content multimedia (RCM), such as text, audio, video, graphics, animation, speech, pattern recognition, still or moving 2D/3D images, AI vision processing, handwriting recognition, security processing, etc. Data can be from multiple remote or local content sources and be for multiple remote or local content destinations. Content synchronization can be from various combinations of audio/video/data from multiple sources, with multiple content streams. Applications can encode and decode and can run in real-time, interactively, with synchronization at the data source, reconstruction at the data destination, and data type composition or data type protection. FIG. 5 illustrates an exemplary hardware infrastructure implementation for use with the present multiple first system with expansions of various applications from audio and video streams.

Within a network-centric computing model, a daunting challenge is managing the distributed data and facilitating localized management of that data. An architectural approach that addresses these requirements is commonly referred to as the distributed data framework 309. The benefit of the distributed database model is that it guarantees continuous real-time availability of all information critical to the enterprise, and facilitates the design of location transparent software, which directly impacts software module reuse.

Software applications gain reliable, instant access across dynamic networks to information that changes in real-time. The architecture uniquely integrates peer-to-peer Data Distribution Service networking, and real-time, in-memory database management systems (DBMS) into a complete solution that manages storage, retrieval, and distribution of fast changing data in dynamically configured network environments. It guarantees continuous availability in real-time of all information that is critical to the enterprise. DDS technology is employed to enable a truly decentralized data structure for distributed database management while DBMS technology is used to provide persistence for real-time DDS data.

According to one embodiment, embedded applications do not need to know SQL or OBDC semantics and enterprise applications are not forced to know publish-subscribe semantics. Thus, the database becomes an aggregate of the data tables distributed throughout the system. When a node updates a table by executing a SQL INSERT, UPDATE, or DELETE statement on the table, the update is proactively pushed to other hosts that require local access to the same table via real-time publish-subscribe messaging. This architectural approach enables real-time replication of any number of remote data tables.

FIG. 4 illustrates an exemplary hardware infrastructure for use with the present system, according to one embodiment. A host 406 is in communication with various multi-core clusters. In FIG. 1, the host might be system 101 without including system 102. The host 406 can, in general, refer to a standard server platform or general purpose computer system. The host commonly has multi-core cluster and multi-tasking OS to control. The hardware infrastructure includes clusters of one or more multi-core processing elements (PEs) or called multi-core clusters systems running the real-time operating system and applications, PE1 402, PE2 403, PE3, 405, and PE4 404. Each PE can correspond to any systems mentioned as (102) or (102_A). Processing elements communicate through inter-processor communication link 407. The inter-processor communication link can be any network connection, parallel bus or serial bus connection. The example of network connection can be any open standards like Ethernet or InfiniBand, and parallel bus connection can be PCI and PCI-x open standard, and serial bus can be PCI-e (PCI Express, multiple generations) and RapidIO.

The examples of host multi-core cluster (406) can refer to x86 multi-core cluster from Intel and AMD, Power and ARM multi-core cluster from IBM and its licensed companies, ARM multi-core cluster and its licensed companies. The examples of multi-tasking OS can refer to Windows, Linux and Unix from various companies. The (406) can be one or more identical clusters and it can represent applications server, web server or database server. It can run all general purpose applications, I/O function and network function services and calls and other system related tasks for OS.

To integrate the description of the exemplary hardware infrastructure, we refer back to the hardware blade described above. Each hardware blade can include a cluster of, for example, Freescale QorIQ 4080 (has 8 CPUs inside one IC package) or more clusters depending on the package density of hardware blade. In general, one Freescale QorIQ 4080 (as an example) cluster corresponds to one cluster of processing elements of hardware infrastructure in FIG. 4 (e.g., PE1 . . . PE18).

If two hardware blades are installed and each blade has the same type of multi-core cluster (e.g., FreescaleQorIQ 4080; 8 cores), it is called homogeneous expansion. In another embodiment, the hardware blade has the capacity to include more than one cluster in one blade.

If two hardware blades are installed and the first blade has FreescaleQorIQ 4080 and the second blade has Cavium Network cluster OCTEON II CN68XX, the Freescale cluster corresponds to PE1 . . . PE18 and the Cavium cluster corresponds to PE2 . . . PE216 (assuming the use of 16 cores). The two hardware blades have non-identical multi-core clusters and it is called heterogeneous expansion.

FIG. 5 illustrates an exemplary hardware infrastructure implementation for use with the present system, according to one embodiment. A host 506 is a standard server, representing an x86 based (Intel or AMD) or any other standard multi-core like Power and ARM cluster. It can perform server applications in communication with various clusters via a host memory/interface controller 501. The hardware infrastructure includes clusters of one or more systems running the same or different operating system and applications. In this example, PE1 (VCSS1) system is the first security system 502, PE2 (VCSS2) system is the second security system 503, PE3 (VCSS3) system is the third security system 505, and PE4 (VCSS4) system is the fourth security system. All security systems can be identical or non-identical in terms of multi-core clusters used, real time operating system running. All systems communicate through inter-process communication link 507 or in shared memory 508. The inter-processor communication link can be any network connection, parallel bus or serial bus connection. The example of network connection can be any open standards Ethernet and InfiniBand, and parallel bus connection can be PCI and PCI-x open standard, and serial bus can be PCI-e (PCI Express, multiple generations) and RapidIO.

The hardware infrastructure includes one or more identical or non-identical “systems” running the same or different operating system and identical or non-identical real time software stacks and applications concurrently with applications software stacks running on host 506.

FIG. 5A illustrates an exemplary hardware infrastructure implementation for use with the present system, according to one embodiment. A host 506 is a standard server, representing an x86 based or any other standard multi-core like Power and ARM cluster. It can perform server applications in communication with various clusters via a host memory/interface controller 501. The hardware infrastructure includes clusters of one or more systems running the identical or non-identical operating system and applications. In this example, (VCNIS1) system is a network and I/O clusters running multiple network, file system and I/O stacks 502, (VCNIS2) system is a second network and I/O clusters running multiple network, file system and I/O stacks 503, (VCNIS3) system is third network and I/O clusters running multiple network, file system and I/O stacks 505, and (VCNIS4) system is a fourth network and I/O clusters running multiple network, file system and I/O stacks for the future applications. All systems communicate through inter-process communication link 507 or in shared memory 508. The example of network connection can be any open standards Ethernet or InfiniBand, and parallel bus connection can be PCI and PCI-x open standard, and serial bus can be PCI-e (PCI Express, multiple generations) and RapidIO.

The hardware infrastructure includes one or more identical or non-identical “systems” running the identical or non-identical operating system and identical or non-identical real time software stacks and applications software stacks concurrently with applications software stacks running on host 506.

FIG. 5B illustrates an exemplary hardware infrastructure implementation for use with the expansion of present system (102) and (102_A) into application server (101), according to one embodiment. A host 506 is a standard server, representing an x86 based or any other standard multi-core like Power and ARM cluster. It can perform server applications in communication with various clusters via a host and memory interface 501. The hardware infrastructure includes clusters of one or more identical or non-identical system (102) and (102_A) running the same or different operating system and applications. The hardware infrastructure includes one or more identical or non-identical “systems” running the identical or non-identical operating system and identical or non-identical real time software stacks and applications concurrently with applications software stacks running on host 506.

FIG. 5C illustrates an exemplary hardware infrastructure implementation for use with the present system, according to one embodiment. A host 506 is a standard server, representing an x86 based or any other standard multi-core like Power and ARM cluster. It can perform server applications in communication with various clusters via a host and memory interface 501. The hardware infrastructure includes clusters of one or more systems running the same or different operating system and applications. In this example, (VCSS1) system is security clusters and stacks 502, (VCSS2) system is a security clusters and stacks 503, (VCNIS1) is a network and I/O clusters and stacks 505, and (VCNIS2) system is a network and I/O clusters and stacks. Multiple systems communicate through inter-process communication link 507 or in shared memory 508. The inter-processor communication link can be any network connection, parallel bus or serial bus connection. The example of network connection can be any open standards like Ethernet or InfiniBand, and parallel bus connection can be PCI and PCI-x open standard, and serial bus can be PCI-e (PCI Express, multiple generations) and RapidIO.

The hardware infrastructure includes one or more identical or non-identical “systems” running the identical or non-identical operating system and identical or non-identical real time software stacks and applications concurrently with applications software stacks running on host 506.

FIG. 5D illustrates an exemplary hardware infrastructure implementation for use with the present system 102, 102_A and future new system (102_B) integrated into or with application server 101, according to one embodiment. The future system (102_B) is a new data driven system and the applications are based on, e.g. pattern recognition, imaging or AI applications mentioned before as any rich content multi-media data types. A host 506 a standard server, representing an x86 based or any other standard multi-core like Power and ARM cluster. It can perform server applications is in communication with various clusters via a host and memory interface 501. The hardware infrastructure includes one or more identical or non-identical “systems” running the identical or non-identical operating system and identical or non-identical real time software stacks and applications concurrently with applications software stacks running on host 506. The future system (102_B) is new data drive system and the new applications, e.g., pattern recognition, or data analytics of artificial intelligence, can be expanded through (102_B) as multiples homogeneous or heterogeneous or intermixed systems with different type of data driven systems

FIG. 5E illustrates an exemplary hardware infrastructure implementation for use with the present system, according to one embodiment. A host 506 is a standard server, representing an x86 based (Intel or AMD) or any other standard multi-core like Power and ARM cluster. It can perform server applications in communication with various clusters via a host memory/interface controller 501. In this example, PE1 (VCNIS1) system is a Network and I/O clusters and stacks 502, PE2 (VCSS2) system is a security clusters and stacks 503, PE3 (VCNS1) system is a video encode (compression) and decode (decompression) clusters and stacks 505, and PE4 (VCNS2) system is a new data clusters and stacks 504. Multiple systems communicate through inter-process communication link 507 or in shared memory 508. PE3 is a new data applications (video) running in its multi-core clusters and software application. PE4 can be any new data type system for example, imaging applications, running its application in its multi-core clusters. The hardware infrastructure includes one or more identical or non-identical “systems” running the identical or non-identical operating system and identical or non-identical real time software stacks and applications concurrently with applications software stacks running on host 506.

FIG. 6 illustrates an exemplary system level layout with virtualization support for use with the present system, according to one embodiment. An application server 601, when virtualized, includes one or more virtual hosts, which are virtualized and have virtual machines running in virtual hosts 610 and 611. Virtual host has various virtual machines running and managed through host hypervisor (609). Each virtual machines (VM) running includes operating systems (OS) and applications (App). The server 601 has virtual machines running on multi-core cluster & memory 608 and requesting for packet and/or security application processing. The multi-core cluster & memory 608 and hypervisor (609) communicate with a network interface cards (NIC) 607 through drivers 626 to access network 615 via PCI-e backplane 606 when VCSS 602 is not present. When VCSS 602 is installed and activated, middleware 612 of virtualized system 601, which is part of software infrastructure 301, communicates with the VCSS 602 and a hypervisor 609, middleware 617 of real time system and converts all services call or APIs from system 601 into various virtual machines running in VCSS 602 and real-time hypervisor 604 handles resource scheduling and allocation in addition to virtual machines management. VCSS 602 includes a hardware blade having a multi-core cluster 605 (HW/Multi-Core Cluster & memory), a real-time hypervisor 604 for scheduling and allocating resources, an interface with virtual machine support 603, and several security virtual machine functions (SF1, SF2, . . . , SFn) 613 and packet processing virtual machine functions (PKT1, PKT2, . . . , PKTn) 614 stored in memory of 605, middleware software 617 which is used by hypervisor 604 and interface with VM support 603 to interface to various virtual machine functions and hardware drivers (616) which are used by multi-core cluster 605 (HW/Multi-core Cluster & memory) to control any hardware functional blocks needed in system VCSS 602, e.g., hardware functional block of NIC (607) or any other blocks. A more detailed description of the drivers 616, 626 will be explained follows below.

In computing, a device driver (commonly referred to as simply a driver) is a computer program that operates or controls a particular type of device that is attached to a computer. A driver provides a software interface to hardware devices, enabling operating systems and other computer programs to access hardware functions without needing to know precise details of the hardware being used.

Hypervisor 609 (or called host hypervisor), also referred to as a virtual machine manager (VMM), allows multiple operating systems, termed guests, to run concurrently on a host computer or allow the transfer of virtual machines from storage systems and other servers into (601) when needed through (NIC) 607 or PCI-e (606). It is so named because it is conceptually one level higher than a supervisory program. The hypervisor presents to the guest operating systems a virtual operating platform and manages the execution of the guest operating systems. Multiple instances of a variety of operating systems may share the virtualized hardware resources. Hypervisors are installed on server hardware whose task is to run guest operating systems. Hypervisor virtualization systems are used for similar tasks on dedicated server hardware, but also commonly on desktop, portable and even handheld computers. Examples of a commercial product of host hypervisor 609 include but not limited to products offered like vSphere and ESXi from VMware, Xen from Citrix, KVM from Red Hat and Hyper-V from Microsoft.

Real time hypervisor 604, sometime refers to embedded hypervisor, is a real time based hypervisor. The embedded hypervisor is used in the real-time embedded system virtualization. It allows developers to leverage multiple real-time operating systems in a single device so they can expand and enhance device functionality; it facilitates the adoption of multi-core clusters by increasing reliability and reducing risk; and it provides the new software configuration options required to architect next-generation embedded devices. Examples of embedded hypervisors on the hardware blade include but not limited to products offered by Windriver, Mentor Graphics and Green Hills Software or any similar products offered from any commercial Open Source real time hypervisor or similar products by any semiconductor vendors, e.g., from Freescale, Cavium Networks, ARM and Intel or any other in-house development embedded hypervisors.

Several security virtual machine functions SF1, SF2, . . . , SFn (613) and packet processing virtual machine functions PKT1, PKT2, . . . , PKTn (614) and all other real time based virtual machines are sharing the HW/multi-core cluster & memory 605. Since they are in software instances form, they can be stored in the local memory in HW/multi-core cluster & memory 605 during the idle state or external storage systems and activated by the embedded hypervisor 604 and brought in through control of software infrastructure, when needed. In addition, the hypervisor 609 running in the application server 601 can activate the SF1 . . . SFn or PKT1 . . . PKTn virtual machines on behalf of the virtual machines running in 610 and/or 611. When virtual machine in 611 or 610 requires the functions of network packet processing and security functions processing, they will send the requests into interface of 603. The middleware 612 converts the service requests for the interface 603. After interface 603 receives the requests, it invokes the PKT1 . . . PKTn (614) to service the network access request. Same situation applies to security virtual machines SF1 . . . SFn (613). If virtual machine in 611 or 610 requires the services of security functions, the middleware 612 converts the request for the interface 603. Interface 603 then reacts like a server farm to serve the security requests to invoking virtual machines SF1 or SF2 . . . SFn through middleware 617 via interface 603. Once services are completed, the results are returned to virtual machine 611 or 610 through 612. A VCSS (602) can be further expanded according to one embodiment listed below. SF1 . . . SFn or PKT1 . . . PKTn virtual machines can be also further expanded to other real-time virtual machines for RCM applications listed below. The hardware infrastructure includes one or more identical or non-identical “multiple systems” running the identical or non-identical real time hypervisors, and identical or non-identical real time software virtual machines can run concurrently with applications and virtual machines running on virtualized host 611 or 610 in system 601. The multiple “virtualized systems”, with identical or non-identical multi-core clusters, with identical or non-identical real time base hypervisors can have identical or non-identical real time software stacks running concurrently with respect to identical or non-identical multi-tasking virtual machines (instances) and applications running concurrently with (610) and (611) in system 601. According to one embodiment, another aspect of the present system includes providing virtualization of security and network packet processing. A virtualized security platform, including combination of hardware multi-core cluster (211) and software platform, built-in on top of the hardware blades, is the foundation of cloud computing security platform. In addition, it includes additional software virtual machines running to offload network packet processing and security virtual machines into real time software stacks running from a virtualized server of system (101) into (102). The virtualized network packet processing, network services and security functions are then, instead, handled by virtual machines in virtual hosts can be handled by virtual machines in real time system (102).

FIG. 6A illustrates an exemplary system level layout with virtualization support for use with the present system, according to one embodiment. An application server 601, when virtualized, includes one or more virtual hosts, which are virtualized and have virtual machines running in virtual hosts 610 and 611. Virtual host has various virtual machines running and managed through host hypervisor (609). Each virtual machines (VM) running includes operating systems (OS) and applications (App). The server 601 has virtual machines running on multi-core cluster & memory 608_A and requesting for network function processing, network services processing and/or I/O file system, I/O data cache and control application processing. The multi-core cluster & memory 608 and hypervisor (609) communicate with a network interface cards (NIC) 607 through drivers 626 to access network 615 via PCI-e backplane 606 when VCNIS 602_A is not present. When VCNIS 602_A is installed and activated, middleware 612 of virtualized system 601, which is part of software infrastructure 301, communicates with the VCNIS 602_A and a hypervisor 609, middleware 617_A of real time system and converts all services call or APIs from system 601 into various virtual machines running in VCNIS 602_A and real-time hypervisor 604_A handles resource scheduling and allocation in addition to virtual machines management. VCNIS 602 includes a hardware blade having a multi-core cluster 605 (HW/Multi-Core Cluster & memory), a real-time hypervisor 604_A for scheduling and allocating resources, an interface with virtual machine support 603_A, and several network services virtual machine (Net1, Net2, . . . , Netn) 613 and I/O processing virtual machine functions (IO1, IO2, . . . , IOn) 614_A stored in memory of 605_A, middleware software 617_A which is used by embedded hypervisor 604_A and interface with VM support 603_A to interface to various virtual machine functions and hardware drivers (616_A) which are used by multi-core cluster 605_A (HW/Multi-core Cluster & memory) to control any hardware functional blocks needed in system VCNIS 602_A, e.g., hardware functional block of NIC (607) or any other blocks. Several network services processing virtual machine functions Net1, Net2, . . . , Netn (613_A), I/O processing virtual machine functions IO1, IO2, . . . , IOn (614_A) and all other real time based virtual machines are sharing HW/Multi-core Cluster & memory 605_A. Since they are in software instances form, they can be stored in the local memory in HW/Multi-core Cluster & memory 605_A during the idle state or external storage systems and activated by the embedded hypervisor 604_A and brought in through control of software infrastructure, when needed. In addition, the hypervisor 609 running in the application server 601 can activate the Net1 . . . Netn or IO1 . . . IOn virtual machines on behalf of the virtual machines running in 610 and/or 611. When the virtual machine of 611 or 610 requests the functions of network services or I/O processing, those requests are sent into interface of 603_A. The middleware 612 converts the service requests for the interface 603_A. After interface 603_A receives the requests, it invokes the Net1 . . . Netn (614_A) to service the network access or network service request. Same situation applies to I/O processing virtual machines IO1 . . . IOn (613_A). If virtual machine in 611 or 610 requires the services of I/O functions, the middleware 612 converts the request for the interface 603_A. Interface 603_A then reacts like a server to serve the security requests by invoking virtual machines 101 or 102 . . . IOn through middleware (617_A). Once services are completed, the results are returned to virtual machine 611 or 610 through 612.

The hardware infrastructure includes one or more identical or non-identical “multiple virtualized systems” running the identical or non-identical real time hypervisors, and identical or non-identical real time software virtual machines can run concurrently with applications and virtual machines running on virtualized host 611 or 610 in system 601. The multiple virtualized “systems”, with identical or non-identical multi-core clusters, with identical or non-identical real time base hypervisors can have identical or non-identical real time software stacks running concurrently with respect to identical or non-identical multi-tasking virtual machines (instances) and applications running concurrently with (610) and (611) in system 601. According to one embodiment, another aspect of the present system includes providing virtualization of network services and I/O file system, I/O data cache and I/O control functions services processing. A virtualized network and I/O platform, including combination of hardware multi-core cluster (211) and software platform, built-in on top of the hardware blades, is the foundation of cloud computing network and I/O platform. In addition, it includes additional software virtual machines running to offload network services processing and I/O virtual machines into real time software stacks running from a virtualized server of system (101) into (102_A). The virtualized network services processing and I/O file system, I/O data cache and I/O functions are then, instead, handled by virtual machines in virtual hosts can be handled by virtual machines in real time system (102_A).

FIG. 6B illustrates an exemplary system level layout with virtualization support for use with the present virtualized system VCNS 602_B integrated into 601, according to one embodiment. Several new real time based virtual machine functions, New1 . . . Newn and IOnew1 . . . IOnewn can be expanded similar to FIG. 6 or FIG. 6A.

FIG. 6C illustrates an exemplary system level layout with virtualization support for use with the expansion of present virtualized system 602_A and 602 integrated into virtualized application server 601, according to one embodiment. All the real time virtual machines (SF1 . . . SFn), (PK1 . . . PKn), (Net1 . . . Netn) and (IO1 . . . IOn) can be running concurrently with virtual machines running in (610) and (611), when invoked.

We can therefore, following the same scheme in the system level layout with virtualization support for use with the expansion of present virtualized system 602, 602_A and 602_B integrated into virtualized 601. All the real time virtual machines (SF1 . . . SFn), (PK1 . . . PKn), (New1 . . . Newn) (Net1 . . . Netn) and (IO1 . . . IOn), (IOnew1 . . . IOnewn) can be running concurrently with virtual machines running in (610) and (611), when invoked. The multiple “virtualized systems”, with identical or non-identical multi-core clusters, with identical or non-identical real time base hypervisors can have identical or non-identical real time software stacks running concurrently with respect to identical or non-identical virtual instances and applications running in (610) and/or (611) in (601).

FIG. 6D illustrates an exemplary system level layout with virtualization support for use with the present virtualized system 602_D integrated into 601, according to one embodiment. Several new real time based virtual machine functions, New1, New2 . . . Newn and Dat1, Dat2 . . . Datn can be expanded similar to FIG. 6, FIG. 6A or FIG. 6B. A VCNew (602_D) can be further expanded according to one the hardware infrastructure includes one or more identical or non-identical “virtualized systems” running the identical or non-identical real time hypervisors and identical or non-identical real time software virtual machines running concurrently with applications virtual machines running in (610) and/or (611) on virtualized system 601.

FIG. 6E illustrates an exemplary system level layout with virtualization support for use with the present virtualized system 602_D and 602_A both are integrated into 601, according to one embodiment. Several new real time based virtual machine functions, New1, New2 . . . Newn and Dat1, Dat2 . . . Datn can be expanded similar to FIG. 6 C. A VCNew (602_D) and VCNIS (602_A) can be further expanded according to the rules mentioned in the previous exemplary of FIG. 6C.

FIG. 7 illustrates a block diagram of the Freescale QorIQ T4240 Multi-core processor as previously discussed.

FIG. 8 illustrates a block diagram of the Cavium Octeon III CN78XX series Multi-core processor as previously discussed.

According to one embodiment, a cloud-based architecture provides a model for cloud security consisting of service oriented architecture (SOA) security layer or other services that resides on top of a secure virtualized runtime layer. A cloud delivered services layer is a complex, distributed SOA environment. Different services are spread across different clouds within an enterprise. The services can reside in different administrative or security domains that connect together to form a single cloud application. A SOA security model fully applies to the cloud. A web services (WS) protocol stack forms the basis for SOA security and, therefore, also for cloud security.

One aspect of an SOA is the ability to easily integrate different services from different providers. Cloud computing is pushing this model one step further than most enterprise SOA environments, since a cloud sometimes supports a very large number of tenants, services and standards. This support is provided in a highly dynamic and agile fashion, and under very complex trust relationships. In particular, a cloud SOA sometimes supports a large and open user population, and it cannot assume an established relationship between a cloud provider and a subscriber.

It should be understood by one having ordinary skill in the art that the present system is not limited to an implementation the presently disclosed multi-core cluster configuration and that embodiments including any appropriate substitute achieve the present objective. The current specification and diagrams include having security software applications, network packet processing, network services, I/O file system, I/O data cache and I/O control functions and embodiments also including audio compression and decompression, video compression and decompression. The implementation can be extended to the imaging compression and decompression, speech compression and decompression or any appropriate substitute of RCM (rich content multimedia) and any rich data types mentioned in the specification to achieve the present objective.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, SSD, NVM or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

A “systems of system” and method for virtualization and cloud security, virtualization and cloud network and I/O are disclosed. Although various embodiments have been described with respect to specific examples and systems, it will be apparent to those of ordinary skill in the art that the concepts disclosed herein are not limited to these specific examples or systems but extends to other embodiments as well. Included within the scope of these concepts are all of these other embodiments as specified in the claims that follow.

What is claimed:

1. A distributed computing system, comprising:
a network interface and/or an inter-processor communication link;
a first processing cluster coupled to the network interface and/or the inter-processor communication link, the first processing cluster comprising one or more hardware cores, wherein the first processing cluster is configured to execute a multitasking operating system and/or is configured to use a multitasking instruction set;
a second processing cluster coupled to the network interface and/or the inter-processor communication link, coupled to the first processing cluster, wherein the second processing cluster comprises one or more hardware cores, wherein the second processing cluster is configured to execute a real-time operating system and/or is configured to use a real-time instruction set;
a first set of agents that are executed by the real-time operating system and that are configured to receive real-time processing requests from the first processing cluster and return processing results for those real-time processing requests to the first processing cluster; and
a set of software stacks that allocate processes of a program executing on the first processing cluster according to real-time processing needs specific to the processes, thereby routing processes needing real-time processing to the second processing cluster.
wherein the real-time processing requests comprises one or more I/O functions.

2. The distributed computing system of claim 1, wherein said one or more I/O functions is comprised of a data cache function and an I/O software control function.

3. The distributed computing system of claim 2 wherein said I/O function stores and organizes at least one computer file and access said computer file when requested.

4. The distributed computing system of claim 3 wherein said computer file is located in a storage device in a local system or over a network.

5. The distributed computing system of claim 4 wherein said storage device is a hard disk, a CD—ROM or SSD or non-volatile memory (NVM) or hybrid storage mixed hard disk and SSD/NVM

6. The distributed computing system of claim 3 wherein said computer file can be managed, accessed, read, stored and maintained by file systems as a shared file system, and/or a network file system, and/or an object file system.

7. The distributed computing system of claim 4 wherein said multiple computer files are located in a storage device in a local system or over a network.

8. The distributed computing system of claim 5 wherein said storage devices are multiple hard disks, CD—ROMs and/or SSDs and/or non-volatile memories (NVM) and/or hybrid storages mixed hard disks and SSDs/NVMs

9. The distributed computing system of claim 7 wherein said multiple computer files can be managed, accessed, read, stored and maintained by one or more file systems as a shared file system, and/or a network file system, and/or an object file system.

10. The distributed computing system of claim 1 wherein said first processing cluster is managed by a virtualized server system.

11. The distributed computing system of claim 1, wherein the second processing cluster further comprises a real-time hypervisor that coordinates multiple cores of the second processing cluster to allocate requests for services from the first processing cluster to virtual machines executed by cores of the second processing cluster managed by the real-time hypervisor.

12. The distributed computing system of claim 11, wherein the first processing cluster is managed by a multitasking hypervisor or a multitasking operating system with more than one cores

13. The distributed computing system of claim 11, wherein the first processing cluster has more than one identical cluster is managed by a multitasking hypervisor or a multitasking operating system with more than one clusters

14. The distributed computing system of claim 1, wherein the second processing cluster is managed by a real-time hypervisor or a real-time operating system with more than one clusters

15. The distributed computing system of claim 1, wherein the second processing cluster has more than one identical clusters is managed by a real-time hypervisor or a real-time operating system consist of at least two clusters

16. The distributed computing system of claim 1, further comprising: application layer server agents, middleware server agents executing in the second processing cluster; and corresponding middleware sockets, middleware client agents executing in the first processing cluster.

17. The distributed computing system of claim 1, wherein the second processing cluster comprises a plurality of types of cores, with at least two distinct cores optimized for distinct operations.

18. The distributed computing system of claim 1, wherein the second processing cluster comprises a plurality of types of cores, with at least two distinct clusters optimized for distinct operations.

19. The distributed computing system of claim 17, wherein the distinct operations include said I/O function, network function, network services, a security function, a rich content media compression (encoding) and decompression (decoding) function.

20. The distributed computing system of claim 19, wherein the second processing cluster comprises a plurality of types of cores, with at least two distinct cores optimized for more than one distinct operations.

21. The distributed computing system of claim 19, wherein the second processing cluster comprises a plurality of types of cores, with at least two distinct clusters optimized for more than one distinct operations.

22. The distributed computing system of claim 2, wherein said one or more data cache functions can be implemented with DRAM, SRAM, SSD, non-volatile memory (NVM) or hybrid data cache among different memories, DRAM, SRAM, SSD, and NVM.

23. The distributed computing system of claim 2, wherein said one or more data cache functions can use more than one DRAM, SRAM, SSD, non-volatile memory (NVM) as data cache or more than one hybrid data cache among different memories, DRAM, SRAM, SSD, and NVM as data cache.

24. The distributed computing system of claim 19, further comprising program code to implement one or more I/O function, network function, network services, VLAN, Link Aggregation, GRE encapsulation, GTP and IP over IP tunneling, Layer 2/3 forwarding with virtual routing management, routing and virtual routing, network overlay termination, TCP termination, traffic management, service chaining, scaling to unlimited flows, virtual address mapping functions and buffer management, a security function, a rich content media compression (encoding) and decompression (decoding) function.

25. The distributed computing system of claim 16, wherein a new program code can be downloaded by said middleware client agent in said first processing cluster and to said second processing cluster for execution by said application layer server agents and said middleware server agents and said middleware client agents.

26. The distributed computing system of claim 16, wherein a new virtual machine can be downloaded by said middleware client agent in said first processing cluster and to said second processing cluster for execution by said application layer server agents and said middleware server agents and said middleware client agents.

27. The distributed computing system of claim 16, wherein a new service can be downloaded by said middleware client agent in said first processing cluster and to said second processing cluster for execution by said application layer server agents and said middleware server agents and said middleware client agents.

28. A method of computing over a distributed system, comprising:
a. executing application processes using a multitasking cluster, the multitasking cluster comprising one or more hardware cores configured to execute a multitasking operating system and/or configured to use a multitasking instruction set;
b. executing a real-time operations cluster comprising one or more hardware cores configured to execute a real-time operating system and/or configured to use a real-time instruction set wherein said real-time instruction set is comprised of one or more I/O function;
c. parsing operations of an application into real-time and non-real-time processes;
d. communicating the real-time processes as requests over a network connection and/or an inter-processor communication link from the multitasking processing cluster to the real-time operations cluster; and
e. providing real-time process results from the real-time operations cluster to the multitasking cluster.

29. The method of claim 28, wherein said one or more I/O function is comprised of a data cache function and an I/O software control function.

30. The method of claim 29, wherein said I/O function stores and organizes at least one computer file and access said computer file when requested.

31. The method of claim 30 wherein said computer file and data is located in a storage device in a local system or over a network.

32. The method of claim 31 wherein said storage device is a hard disk, a CD—ROM or a SSD, or non-volatile memory (NVM) or hybrid storage mixed hard disk and SSD/NVM.

33. The method of claim 30 wherein said computer files can be managed, accessed, read, stored and maintained by file systems as a shared file system, and/or a network file system, and/or an object file system.

34. The distributed computing system of claim 31 wherein said multiple computer files are located in a storage device in a local system or over a network.

35. The distributed computing system of claim 32 wherein said storage devices are multiple hard disks, CD-ROMs and/or SSDs and or non-volatile memories (NVM) and or hybrid storages mixed hard disks and SSDs/NVMs

36. The distributed computing system of claim 34 wherein said multiple computer files can be managed, accessed, read, stored and maintained by one or more file systems as a shared file system, and/or a network file system, and/or an object file system.

37. The method of claim 28 wherein said first processing cluster is managed by a virtualized server system.

38. The method of claim 28, wherein the first processing cluster is managed by a multitasking hypervisor or a multitasking operating system with more than one cores.

39. The method of claim 28, wherein the first processing cluster has more than one identical cluster is managed by a multitasking hypervisor or a multitasking operating system with more than one clusters.

40. The method of claim 28, wherein the second processing cluster is managed by a real-time hypervisor or a real-time operating system.

41. The method of claim 28, further comprising: an application layer server agents, a middleware server agents executing in the second processing cluster; and a corresponding middleware client agents executing in the first processing cluster.

42. The method of claim 28, wherein the second processing cluster comprises a plurality of types of cores, with at least two distinct cores optimized for distinct operations.

43. The method of claim 28, wherein the second processing cluster comprises a plurality of types of cores, with at least two distinct clusters optimized for distinct operations.

44. The method of claim 41, wherein the distinct operations include said I/O function, network function, network services, a security function, a rich content media compression (encoding) and decompression (decoding) function.

45. The method of claim 44, wherein the second processing cluster comprises a plurality of types of cores, with at least two distinct cores optimized for more than one distinct operations.

46. The method of claim 44, wherein the second processing cluster comprises a plurality of types of cores, with at least two distinct clusters optimized for more than one distinct operations.

47. The method of claim 28, wherein the second processing cluster further comprises a real-time hypervisor that coordinates multiple cores of the second processing cluster to allocate requests for services from the first processing cluster to virtual machines executed by cores of the second processing cluster managed by the real-time hypervisor.

48. The method of claim 28, wherein the real-time operations cluster further comprises a real-time hypervisor that coordinates multiple clusters of the real-time operations cluster to allocate requests for services from the multitasking cluster to virtual machines managed by the real-time hypervisor and executed by multiple clusters of the real-time operations.

49. The method of claim 28, wherein the multitasking cluster is managed by a multitasking hypervisor or a multitasking operating system.

50. The method of claim 28, wherein the real-time operations cluster is managed by a real-time hypervisor or a real-time operating system.

51. The method of claim 28, wherein the second processing cluster comprises a plurality of types of cores, with at least two distinct clusters optimized for distinct operations.

52. The method of 29, wherein said one or more data cache functions can be implemented with DRAM, SRAM, SSD, non-volatile memory (NVM) or hybrid data cache among different memories, DRAM, SRAM, SSD, and NVM.

53. The method of 29 wherein said one or more data cache functions can use more than one DRAM, SRAM, SSD, non-volatile memory (NVM) as data cache or more than one hybrid data cache among different memories, DRAM, SRAM, SSD, and NVM as data cache.

54. The method of 41 wherein a new program code can be downloaded by said middleware client agent in said first processing cluster and to said second processing cluster for execution by said application layer server agents and said middleware server agents and said middleware client agents.

55. The method of 41 wherein a new virtual machine can be downloaded by said middleware client agent in said first processing cluster and to said second processing cluster for execution by said application layer server agents and said middleware server agents and said middleware client agents.

56. The method of 41 wherein a new service can be downloaded by said middleware client agent in said first processing cluster and to said second processing cluster for execution by said application layer server agents and said middleware server agents and said middleware client agents.

57. The distributed computing system of claim 1, wherein the first processing cluster comprises a plurality of types of cores, is managed by a multitasking hypervisor or a multitasking operating system with more than one cores with at least two distinct cores optimized for distinct operations.

58. The distributed computing system of claim 1, wherein the first processing cluster comprises a plurality of types of cores, is managed by a multitasking hypervisor or a multitasking operating system with more than one clusters with at least two distinct clusters optimized for distinct operations.

59. The distributed computing system of claim 1, wherein the first processing cluster comprises a plurality of application stacks is managed by a multitasking hypervisor or a multitasking operating system with more than one cores with at least two distinct cores optimized for distinct operations.

60. The distributed computing system of claim 1, wherein the first processing cluster comprises a plurality of application stacks is managed by a multitasking hypervisor or a multitasking operating system with more than one clusters with at least two distinct clusters optimized for distinct operations.

61. The distributed computing system of claim 1, wherein the second processing cluster comprises a plurality of types of real time application stacks, with more than two clusters and at least two distinct cores optimized for distinct operations.

62. The distributed computing system of claim 1, wherein the second processing cluster comprises a plurality of types of real time application stacks, with more than two clusters and at least two distinct clusters optimized for distinct operations.

63. The distributed computing system of claim 19, wherein the second processing cluster comprises a plurality of types of real time application stacks, with more than two clusters and at least two distinct cores optimized for distinct operations.

64. The distributed computing system of claim 19, wherein the second processing cluster comprises a plurality of types of real time application stacks, with more than two clusters and at least two distinct clusters optimized for distinct operations.

65. The method of claim 28, wherein the first processing cluster comprises a plurality of types of cores, is managed by a multitasking hypervisor or a multitasking operating system with more than one cores with at least two distinct cores optimized for distinct operations.

66. The method of claim 28, wherein the first processing cluster comprises a plurality of types of cores, is managed by a multitasking hypervisor or a multitasking operating system with more than one clusters with at least two distinct clusters optimized for distinct operations.

67. The method of claim 28, wherein the first processing cluster comprises a plurality of application stacks is managed by a multitasking hypervisor or a multitasking operating system with more than one cores with at least two distinct cores optimized for distinct operations.

68. The method of claim 28, wherein the first processing cluster comprises a plurality of application stacks is managed by a multitasking hypervisor or a multitasking operating system with more than one clusters with at least two distinct clusters optimized for distinct operations.

69. The method of claim 28, wherein the second processing cluster comprises a plurality of types of real time application stacks, with more than two clusters and at least two distinct cores optimized for distinct operations.

70. The method of claim 28, wherein the second processing cluster comprises a plurality of types of real time application stacks, with more than two clusters and at least two distinct clusters optimized for distinct operations.

71. The method of claim 44, wherein the second processing cluster comprises a plurality of types of real time application stacks, with more than two clusters and at least two distinct cores optimized for distinct operations.

72. The method of claim 44, wherein the second processing cluster comprises a plurality of types of real time application stacks, with more than two clusters and at least two distinct clusters optimized for distinct operations.
